(19) United States
(12) Patent Application Publication
(10) Pub. No.: US 2020/0024014 A1
(43) Pub. Date: Jan. 23, 2020

(54) Method for Consolidated Order-Picking and Packing of Articles, Order-Picking and Packing System and Order-Picking Container

(71) Applicant: Dr. Thomas + Partner GmbH & Co. KG, Stutensee (DE)

(72) Inventor: Karl Warmulla, Karlsruhe (DE)

(21) Appl. No.: 16/496,417

(22) PCT Filed: Mar. 15, 2018
(86) PCT No.: PCT/EP2018/000099

§ 371 Date: Sep. 21, 2019

(30) Foreign Application Priority Data
Mar. 21, 2017 (DE) 10 2017 002 712.9

(51) Int. Cl. B65B 5/06; B65B 35/10; B65G 1/137

(52) U.S. Cl. CPC B65B 5/06; B65G 1/1378; B65B 35/10

(57) ABSTRACT

The present invention relates to a method and a system for automatically consolidating order-picking and packing of articles (A) ready to send. An order-picking container (1), in which articles (A) are grouped, is provided. The method comprises the steps of: a) arranging the order-picking container (1) on a predetermined transfer location (10) and transferring an article (A) to the order-picking container (1), b) moving the filled order-picking container (1) to a predetermined packing station (20) and providing a transport packaging (100) with a downwardly facing opening (101) which is adapted to receive the order-picking container (1), c) arranging the order-picking container (1) through the opening (101) in the transport packaging (100), d) moving the filled order-picking container (10) which is arranged in the transport packaging (100) to a transfer and separating station (30), e) transferring the at least one article (A) from the order-picking container (1) in the transport packaging (100) by means of a vertical turning movement, f) separating the order-picking container (1) from the transport package (100) and g) closing the transport packaging (100). All method steps are carried out automatically in a machine in a continuous process.

The invention relates to a method for the consolidated order-picking and packaging of articles, to an order-picking and packing installation, and to an order-picking container.

Methods and apparatuses for packaging are basically known from the prior art: DE 10 146 790 A1 discloses a method and an apparatus for filling cuboidal containers with filled envelopes, which are inserted with their surfaces lying one on top of the other into the container, and DE 100 19 485 A1 discloses a method and an apparatus for unloading and/or loading trays which have a base, at least two opposite side walls and an open top side for receiving at least one item of goods. Finally, DE 37 08 896 A1 relates to an apparatus for the automatic filling of a container, in particular of a cardboard box with a material, in particular a stacked material, and for applying a lid, which overlaps the walls of the container, to the filled box. Furthermore, DE 39 411 39 A1 discloses a method for producing a palletless packaging unit which is completely wrapped in plastics film and which comprises multiple layers of articles stacked one on top of the other. U.S. Pat. No. 3,605,377 A also discloses an automatic packing machine.

It is also known from the prior art to use manual or machine order-picking systems for compiling articles in accordance with orders from an assortment of articles. In the case of manual systems, the order is compiled by an employee. Machine systems use order-picking robots which, based on received order data, remove the corresponding articles from rack bays and place them into a carried-along order-picking container, or automated order-picking machines in the case of which the assortment of articles is provided in slots adjacent to a conveyor belt. On the conveyor belt, an order-picking container, which is assignable for example by means of a barcode, is moved past the slots which, in accordance with the order, are actuated so as to open so as to discharge the desired articles into the order-picking container.

For the shipment of the articles, said articles are generally inserted into classic cardboard box packaging means, for example set-up boxes and foil pouches. The packaging of the order-picked articles in these packing means is generally performed manually at decentralized workstations by employees. In order to make the packaging secure for transport and prevent damage during shipment, it is necessary, after the arrangement of the articles, in particular in the case of small orders, which commonly include only one to four articles, for sufficient filler material to be introduced into the packing means in order to fill the remaining volume of the packing means. In the case of this type of processing, several dozen employees are required for example for a system with a throughput rate of 10,000 articles per hour. In the present market climate, such consignments are created under highly volatile conditions, in some cases with the demand for delivery on the same day.

DE 38 13 309 A1 describes a method and an arrangement for packaging consignments securely for transport. Here, a transport packaging such as a cardboard box with an open top wall is provided, the articles, with a foil pouch over them, are arranged in the cardboard box, before a lid closes the opening of the cardboard box. The foil pouch has a hose-like mouth piece which projects outward from the cardboard box, such that the foil pouch, after the lid has been fixed to the cardboard box, can be inflated and welded at the mouth piece, in order to thus prevent the articles in the cardboard box from sliding around during transport.

The shipment of articles is commonly performed in fixed transport packagings such as crates and cardboard boxes, which however disadvantageously entail high material consumption and commonly take up a transport volume which is unduly large in relation to the contained volume of goods.

In order to be able to ship goods in pouches, WO 2013/070197 A1 discloses a system and a method for pouch shipment. The pouch shipment system has a crate and multiple pouch protectors. A pouch protector is composed of a base wall, which is designed to support a pouch composed of flexible material, and two side walls, which converge on one another proceeding from the base wall such that they meet at their upper ends in order to receive an opening portion of a pouch. The goods in the pouch are thus, during transport, protected by the pouch protector and the surrounding crate, in which the pouch protectors, owing to their tapering profile, can be arranged in space-saving fashion with the base walls alternately pointing downward and pointing upward.

This however still does not solve the problem of packing the articles picked in accordance with an order securely for transport in a non-rigid transport packaging, such as a paper bag, a bag composed of cardboard or a plastics pouch, in the demanded throughput category, which proceeds for example from 10,000 parts per hour, in the case of orders composed of several parts, without the use of employees.

Proceeding from this prior art, it is an object of the present invention to provide a method in the case of which the articles picked in accordance with an order are packed securely for transport fully automatically and reliably in terms of a process in a transport packaging such as a paper bag, a plastic bag or a plastics pouch.

Said object is achieved by means of a method for the consolidated order-picking and packaging of articles having the features of claim 1.

The further object, that of providing an apparatus suitable for carrying out the method, is achieved by means of the order-picking and packing installation having the features of independent claim 5 and by means of the order-picking container having the features of independent claim 11.

Refinements are specified in the respective subclaims.

In the case of a method according to the invention for the automatic consolidated order-picking and packaging of articles for shipment, all method steps are performed in automated fashion by machine in a continuous process, wherein an order-picking container is provided, in which articles are compiled in accordance with an order. The provision of an order-picking container for the consolidated order-picking of an order from a multiplicity of order-picking containers situated in the process is performed in a dynamic and stochastic manner.

The expression “consolidated order-picking” is to be understood to mean the time-saving compilation of individual parts to form a whole, if for example multiple orders include the same article, such that the number of said articles required for the various orders are provided together in order to then be transferred into the order-picking containers assigned to the orders.

An order-picking container in the process according to the invention may be identified for example by means of an identification feature such as for example a barcode or QR code or by means of an RFID transponder, for example in order to be assigned to a particular order.

To carry out the method,
a) the order-picking container is arranged at a transfer location and at least one article provided in accordance with the order is transferred into the order-picking container,
b) the order-picking container filled with at least one article is moved to a predetermined packing location and, above the packing location, a transport packaging with a downwardly pointing opening is provided. The transport packaging is designed such that it can receive the order-picking container in a closely fitting manner. Then,
c) the order-picking container is transferred through its opening into the transport packaging, and
d) the filled order-picking container arranged in the transport packaging is moved to a retransferring and separating station. In step
e), the at least one article is retransferred from the order-picking container into the transport packaging by means of a 180° turn in relation to the vertical,
f) the order-picking container is separated from the transport packaging in which the article, or several articles, is or are present, and
g) the transport packaging is closed.

In a), the transfer location may, in the presence of multiple transfer locations, be defined arbitrarily by the process dynamics; the process dynamics determine the location. Here, the automatic controller assigns each order to a particular order-picking container, not to a particular transfer location, such that the articles that are to be correspondingly transferred to an order are transferred at the (arbitrarily) transfer location, determined by the process dynamics, at which the assigned order-picking container is arranged. Thus, each order-picking container serves as a dynamic sorting destination in the sense of a flexible destination chute, and, after a transfer of articles has been performed, is transported into the other, subsequent processing zones. After emptying of the order-picking containers and the separation from the transport packaging, the order-picking container can be assigned to a new order and transported, for a corresponding transfer of articles, to a transfer location which is, again, an arbitrary transfer location determined by the process dynamics.

The method permits fully automatic, consolidated order-picking and packaging to the point of making an ordered compilation of articles ready for shipment in transport packagings such as for example paper or plastic bags or plastics pouches or else for example sack-like transport packagings which are composed of a non-rigid material and have a filling opening. With regard to the volume to be shipped, these transport packagings have the advantage that they can be adapted to the actual volume of the articles: for example, a paper bag can, after being filled, be folded over or turned over proceeding from the opening.

According to the invention, it is the intention, by means of the continuous cyclic process, which relates primarily to the continuous transport of the order-picking container, to ensure predetermined throughput times and to reduce the demand on employees, because all method steps can be controlled fully automatically by means of one or more control apparatuses, and/or can take place with closed-loop control in conjunction with suitable sensor arrangements.

The use of paper bags is preferable, because it is possible in this way, for ecological reasons, to also dispense with plastic bags or pouches. The method permits the highest possible process reliability, in particular also for critical goods such as for example shoeboxes with loose lids. The method is particularly advantageous for fulfilling small orders with a number of articles of less than five, but can also be used—depending on article size—in the case of orders with greater numbers of articles.

The order-picking containers used for carrying out the method in a corresponding order-picking and packing installation may be designed in a variety of ways. Depending on the type of order-picking containers used, apparatuses of the installation, and correspondingly also individual details of the method steps, may differ. One type of order-picking container that can be used has a container main body which extends perpendicular to its base surface, wherein base surface refers to the outer base surface, that is to say standing surface, of the order-picking container, by which the order-picking container stands on an underlying surface, for example on a conveying device or a processing location. By contrast, another design of an order-picking container that can be used has a “heel”, that is to say the container main body is inclined at a predetermined angle, which is not 90°, with respect to the base surface. In both embodiments, the container main body may be designed such that the opening delimited by the upper container margin is inclined relative to said base surface, such that the container margin has (in relation to the base surface) a highest and lowest point or at least a higher and a lower edge. Furthermore, in the main body, a wedge may be arranged on the inner base, such that the inner base surface is likewise inclined relative to the base surface of the order-picking container. In one refinement of the method, in step a), the order-picking container that is moved to the predetermined transfer location for the transfer of articles may be tilted with its opening in the direction of an article supply apparatus, such that the at least one article provided in accordance with the order by the supply apparatus slides smoothly into the order-picking container. For “heeled” order-picking containers, the tilting may possibly be omitted—this is dependent on the tilt angle which is provided for the transfer of articles and which is preferably selected such that the articles slide as smoothly as possible, but without stopping, into the order-picking container. That is to say, even a “heeled” order-picking container is tilted if its inclination is smaller than the desired tilt angle.

In the case of order-picking containers which have a lowest point or a lower edge at the container margin that delimits the container opening and/or have a wedge on the base, in step a), the order-picking container is moved to the transfer location such that that side of the order-picking container which has the lowest point or the lower edge at the container margin, and/or at which an acute-angled side of the wedge is arranged, points towards the article supply apparatus. That is to say, in the case in which the order-picking container has both a container margin with a lowest point or a lower edge and has a wedge, the wedge is arranged in the order-picking container such that the acute-angled side of the wedge is arranged on the side with the lowest point or the lower edge.

Further embodiments of the method may comprise at least one of the following steps:
in accordance with the order, that is to say the articles listed in the order, step a) may be repeated for at least one further article at at least one further predetermined transfer location or else at the same transfer location,
before step b), the order-picking container may be moved to a predetermined additional-material location and, there, additional material such as a delivery note, an invoice or advertising media such as flyers etc. may be transferred into the order-picking container,
in step b), for the provision of the transport packaging, a transport packaging with a particular format may be selected in accordance with a specification, which is defined by a quantity or a volume of the articles of the order, from a magazine apparatus, and the transport packaging may be set up and held,
in step c), the order-picking container may be arranged in the transport packaging by means of an upward movement of the order-picking container for insertion into the transport packaging through the opening thereof, during step d), a labelling station may be passed and the transport packaging labeled,
in step e), the turning movement may be performed, which is preferably performed through 180°, in order that, at the end of the turning movement, the transport packaging is arranged upright (or inclined in accordance with “heeled” order-picking containers) with the opening pointing upward. This is performed preferably by guiding and conveying the filled order-picking container, which is arranged in the transport packaging, in a half-looping track, wherein a base of the transport packaging is supported by a corresponding stabilizing track,
in step f), the order-picking container may be separated from the transport packaging by being lifted out. For this purpose, the order-picking container and the transport packaging may be guided and conveyed along tracks which diverge in relation to the vertical, wherein preferably, the order-picking container is guided onward along a rising ramp and the transport packaging is guided onward horizontally, in order to prevent the transport packaging from falling over or the articles from falling out of the transport packaging. For “heeled” order-picking containers, the rising ramp may also diverge in relation to the horizontal, in order to pull the order-picking container out of the transport packaging parallel to the extent of the main body thereof, and thus to prevent jamming.
In step g), for the closure of the transport packaging, said transport packaging may for example be folded over, turned over or rolled up proceeding from the opening side as far as the article or as far as the article positioned closest to the opening. The folded portion is preferably subsequently fixed. This may be realized by adhesive bonding using adhesive or double-sided adhesive tape, tacking or preferably by stitching.
In parallel with step g), the emptied order-picking container may be returned, performing a further turning movement in relation to the vertical, and moved to the transfer station in order to pick up articles in accordance with a further order.

As regards the direction of the upward movement of the order-picking container for the insertion into the transport packaging in step c), the direction of the upward movement may be dependent on the embodiment of the order-picking container used: whereas an order-picking container with a main body extending perpendicular to the base surface can be moved vertically upward into the transport packaging provided directly thereabove, a “heeled” order-picking container with a main body tilted in relation to the vertical will be moved in an upward movement with a superposed horizontal movement component, that is to say on an oblique upward course, in order to be able to be inserted into a transport packaging that is correspondingly inclined and offset in relation to the packing location. The inclination of the oblique upward course, and the offset of the provided transport packaging in relation to the packing location, are dependent on the inclination of the order-picking container. Alternatively, for a heeled order-picking container, it is conceivable for the transport packaging to be provided so as to be duly inclined but vertically directly above the packing location, if the upward movement follows, for example, a zigzag course in order to be able to insert the tilted main body into the transport packaging.

An order-picking and packing installation according to the invention for the automatic, consolidated order-picking and packaging of articles for shipment has order-picking containers and multiple conveying devices for order-picking containers and also supply and transfer apparatuses for articles, and a control apparatus for controlling the entire installation for the automatic, consolidated order-picking and packaging of articles for shipment in a continuous process. Here, the conveying devices for order-picking containers connect at least one transfer station for transferring the articles into the order-picking containers and at least one packing station for packaging the articles in a transport packaging. According to the invention, the packing station that permits the packing into the transport packagings has a packing location for the order-picking container, above which packing location there is arranged an apparatus for providing a transport packaging with a downwardly pointing opening. The opening of the transport packaging is dimensioned to receive the order-picking container. In order that the order-picking container can be received in the transport packaging, the packing location or the apparatus for providing the transport packaging, or both, are designed to perform a movement toward one another.

Preferably, in one embodiment, the packing location is movable upward, whereas the transport packaging is held stationary.

In order to transfer the articles compiled in the order-picking container into the transport packaging, the order-picking and packing installation has a retransferring and separating station which, via conveying devices for order-picking containers, follows the packing station, and which has a turning apparatus for the order-picking containers for performing a turning movement in relation to the vertical, and, following this, a separating apparatus for separating the order-picking container from the transport packaging.

Furthermore, the order-picking and packing installation may have a return device for the order-picking containers and/or a closure station, which, for the closure of the transport packaging, follows the retransferring and separating station via corresponding conveying devices. The return device for the order-picking containers has a second turning apparatus for the order-picking containers for performing a turning movement in relation to the vertical.

The closure station preferably has an apparatus for folding over or rolling up the transport packaging proceeding from the opening side in accordance with a fill volume occupied in the transport packaging by the at least one article, and an apparatus for fixing the folded-over portion, for example by adhesive bonding, welding, tacking or preferably stitching.

The transfer station may have a multiplicity of transfer locations, each of which—at least for the embodiment with non-heeled order-picking container—is assigned a tilting ramp which, at a predetermined inclination angle, connects a plane of the transfer location to a plane, situated thereabove, of a supply apparatus for the articles, on its own or in interaction with a transfer apparatus of the supply apparatus, wherein the tilting ramp is designed to support the order-picking container at the predetermined inclination angle, wherein an opening of the order-picking container points in the direction of the supply apparatus in order to receive the articles, and to set the order-picking container upright again after the filling process has been performed. The transfer locations are also connected by conveying devices. It is self-evidently possible for installations according to the invention to have tilting ramps at the transfer locations also for “heeled” order-picking containers, the main body of which is inclined relative to the vertical; depending on the degree of the inclination of the “heeled” order-picking containers, it is however possible, if appropriate, for tilting ramps to be omitted and for the transfer locations to be configured, in accordance with the “heeled” order-picking container, relative to the supply apparatus or the transfer apparatus thereof such that the opening of the “heeled” order-picking container correspondingly points in the direction of the supply apparatus in order to receive the articles. Basically, in configuring the installation, it must be ensured that the “heeled” order-picking containers are introduced in a correspondingly correct orientation. If appropriate, it is also possible for this purpose to use an automated apparatus which detects the inclination direction of the “heeled” order-picking containers and introduces these in the correct orientation into the installation in order that the container opening points in the correct direction at the processing locations.

The order-picking and packing installation may furthermore have an additional-material station for predetermined additional material, which additional-material station is arranged along the conveying devices between the transfer station and the packing station. Alternatively or in addition, the order-picking and packing installation may have a labelling station for labelling the transport packaging, which labelling station is arranged along the conveying devices between the packing station and the retransferring and separating station.

In one refinement, the additional-material station may have a printer apparatus for printing accompanying documentation, wherein the printer apparatus is configured and/or designed such that a documentation output is situated above a plane defined by the opening of the order-picking containers conveyed along the conveying devices.

The apparatus for providing the transport packaging may have a magazine apparatus with compartments for transport packagings with different formats, a selection apparatus for selecting and isolating a transport packaging of a particular format, and a setting-up and holding apparatus for an unfolded transport packaging with a downwardly pointing opening. The apparatus for providing the transport packaging may be equipped with a corresponding sensor arrangement in order that, in accordance with the specifications from the control apparatus, not only is the suitable transport packaging selected, isolated and set up by means of the selection apparatus, but also, in each magazine apparatus, the stock of transport packagings is monitored and a correct assignment of new transport packagings, which are delivered in stacks, to the respective magazine apparatus can be automatically realized.

At least one lifting apparatus serves for realizing the relative movement between the packing location and the apparatus for providing the transport packaging. Here, the packing location or the apparatus for providing the transport packaging or the setting-up and holding apparatus thereof is or are connected or connectable to a lifting apparatus. It is theoretically also possible for both, packing location and apparatus for providing the transport packaging, or the setting-up and holding apparatus thereof, to each be connected to a lifting apparatus. A preferred variant however provides for the packing location to be connected to a lifting apparatus, because this variant is easier to realize in terms of apparatus than a movable apparatus for providing the transport packaging, or the setting-up and holding apparatus thereof. A lifting apparatus may have one or more lifting cylinders, lifting scissor mechanisms and/or an elevator or lift apparatus, and under this, for example at least one circulating conveyor.

The retransferring and separating station may have, as a turning apparatus, a half-looping track with guide means for the order-picking container and a stabilizing track which runs parallel and which serves for supporting a base of the transport packaging.

The retransferring and separating station may have, as a separating apparatus, tracks which diverge with respect to the vertical, in each case for guiding and conveying the order-picking container and the transport packaging, wherein the upper track for guiding and conveying the order-picking containers adjoins the half-looping track, and the lower track for guiding and conveying the transport packaging adjoins the stabilizing track. Here, preferably, the upper track for guiding and conveying the order-picking containers may be formed as a rising ramp. In the separating apparatus designed for “heeled” order-picking containers, the rising ramp may also diverge in relation to the horizontal, in order to pull the order-picking container parallel to the extent of its main body out of the transport packaging and thus prevent jamming.

The guide means in the half-looping track and in the upper track may preferably be lateral guide rails which are designed to engage with rolling apparatuses of the order-picking container, which rolling apparatuses are arranged laterally on said order-picking container in the vicinity of the base.

As an alternative to the divergent tracks, which have a relatively large space requirement with regard to the longitudinal extent, the retransferring and separating station may, as a separating apparatus, have a space-saving lift apparatus for the order-picking containers, which lift apparatus adjoins the half-looping track. For the transport packagings, a holding location is provided below the lift apparatus along a conveying-away track which, as in the case of the divergent tracks, adjoins the stabilizing track. As the order-picking container is pulled out of the transport packaging by means of the lift apparatus, said transport packaging remains on the holding location before being conveyed via the conveying-away track to the closure station. The lift apparatus may preferably have at least one circulating conveyor which is formed with at least one engagement element for engagement with a turned order-picking container. It is thus conceivable for a circulating conveyor to be able to be used which engages with the order-picking container only on one side. It is however preferably possible to use a pair of circulating conveyors which engage with the order-picking container at both sides in a manner simultaneously coordinated with one another in order to lift said order-picking container. Depending on the type of order-picking containers used, the lift apparatus may be designed to perform a vertical upward movement (for “normal” order-picking containers) or to perform an oblique upward movement (for “heeled” order-picking containers), wherein the incline of the outward movement is correspondingly adapted to the inclination of the order-picking container in order to allow the order-picking container to be pulled out of the transport packaging without jamming.

For fully automated operation, provision is made for the order-picking and packing installation to have at least one control apparatus. All apparatuses and conveying devices of the installation according to the invention are connected to the control apparatus in order to perform the order-picking and consolidation and packing of the articles for shipment fully automatically in a continuous process, wherein the apparatuses and conveying devices of the installation are preferably equipped at least in part with a sensor arrangement which, for the closed-loop control of the processes, is coupled to the at least one control apparatus.

For this purpose, the order-picking and packing installation may have a sensor arrangement, for example read units, for detecting a unique identifying feature for distinguishing each order-picking container, which may for example be a barcode, QR code or RFID chip attached to each order-picking container. The corresponding read units may then be arranged at the transfer station, at the packing station, at each additional-material station, labelling station, closure station and/or at all conveyance-relevant decision positions along the conveying devices for the assignment of the order-picking containers by the control apparatus. One conveyance-relevant decision position along the conveying devices is present for example at the transfer station, which has a multiplicity of transfer locations that can be used in parallel. By means of a read unit which is suitably located upstream of the transfer station along a conveying device, the order-picking containers can, by means of the respective identifying feature, be assigned to a particular order and to a transfer location, at which the transfer of articles in accordance with the order is performed. It would alternatively be possible for each transfer location to be equipped with a read unit for identifying the respective order-picking container. Further conveyance-relevant decision positions along the conveying devices are situated in particular in those installation sections or stations which likewise have multiple processing stations which operate in parallel and which are incorporated into the conveying circuit in parallel in terms of conveyance, for example by means of switches, such that the decision positions at which corresponding read units are to be provided for identification purposes are situated upstream of said switches. Installation sections with such parallel processing locations and with the corresponding decision positions for the assignment of the order-picking containers may be in particular the additional-material station with parallel additional-material locations, the packing station with parallel packing locations, and the closure station with parallel and/or different closure apparatuses. By means of the processing stations with parallel processing locations, it is not only possible for the processing throughput to be increased, but it is also possible for a standstill to be avoided if a fault arises at one of the processing locations, because the order-picking containers can then be assigned to the parallel processing locations by the control apparatus.

Alternatively or in addition, the transfer station may, preferably at the transfer apparatuses, have sensor apparatuses which are positioned such that a completed article transfer and/or protruding articles projecting out of the order-picking container in the transfer position can be detected. In the former case, the control apparatus will cause the filled order-picking container to be set upright and conveyed onward. In the latter case, the filled order-picking container will initially also be set upright by the control apparatus, for example by actuation of the tilting ramp, in order to allow the protruding article to slide into the container, but then tilted again in order to complete the order and/or in order to check whether the article is still protruding. Only when the order has been completed and no further articles are protruding is the order-picking container conveyed onward after being set upright.

A further alternative or additional sensor arrangement may be provided for the apparatus for providing the transport packaging at each magazine apparatus for the purposes of monitoring a stock of transport packagings and for the purposes of automatically assigning new transport packagings. In particular, for this purpose, each cassette carrier may have a corresponding sensor arrangement for the purposes of determining and controlling the fill level and the position of the respective cassette carrier. In this way, by means of the control apparatus, the required replenishment of transport packagings can be planned in good time in order to minimize or prevent deficits or standstills at the packing locations.

Furthermore, the order-picking and packing installation may—depending on the embodiment, if for example this provides the use of different transport packaging formats -have sensor arrangements for the closure station for the purposes of detecting a height of transport packagings being conveyed past, in order to assign the respective transport packaging to a suitable closure apparatus in a manner dependent on the format of said transport packaging. Alternatively, if only identical packaging formats are used, or additionally, the closure station may have one or more fill height sensors for the purposes of detecting the fill height of the articles in the transport packaging, in order that the control apparatus can determine the number of folds for the closure of the transport packaging and can assign the transport packaging to the corresponding apparatuses for the folding-over or rolling-up of the transport packaging proceeding from the opening side.

The embodiments stated here are to be understood as advantageous but not exclusive examples—it is self-evidently possible for further sensor arrangements for the open-loop and closed-loop control of the order-picking and packing installation to be provided, for example weighing sensors, if the weight of the articles compiled in the order-picking container in accordance with the order is of interest for the selection of the packaging material or for the shipment, or sensor devices for detecting malfunctions of the apparatuses at the processing stations or of the conveying devices.

An order-picking container according to the invention which is suitable for use in an order-picking and packing installation according to the invention for carrying out a method according to the invention has an opening which is inclined relative to a base surface of the order-picking container. Furthermore, the order-picking container has lateral rolling apparatuses in the vicinity of the base, which rolling apparatuses are designed for engaging into the lateral guide rails for the conveyance through the turning and separating apparatus.

The order-picking container may have a main body which provides the inclined opening. To improve standing stability, the main body, the cross section of which corresponds to the cross section of the transport packaging, may be arranged in a trough-like stabilizing apparatus which increases the standing surface and which provides the base surface of the order-picking container. The rolling apparatuses are then arranged laterally of the trough margin.

The main body may be arranged at right angles with respect to the base surface in the stabilizing apparatus, wherein the opening that is inclined relative to the base surface of the order-picking container is provided by virtue of a container margin that delimits the opening having a lowest point and a highest point, which forms a guide corner for the introduction into the transport packaging.

Alternatively, for a “heeled” order-picking container, the main body may be arranged so as to be inclined by a predetermined angle with respect to the base surface, preferably in the stabilizing apparatus, wherein the opening that is inclined relative to the base surface of the order-picking container is provided with a lower edge and a higher edge. A suitable main body may also have a container margin with a lowest and a highest point in order to provide the guide corner for the introduction process. The fixed oblique position of the main body makes it possible to prevent goods that are critical in terms of packaging, such as for example shoeboxes with loose lids, from opening after being transferred into the order-picking container and also during the further transport through the installation, because the articles bear against a container wall which is the “lower” container wall in the inclined state.

In order to further improve the introduction into the transport packaging, the container margin around the opening may have roundings at least in certain portions. It is thus possible for an encircling bead or else bead-like portions to be provided at the order-picking container margin at the opening side, which bead-like portions simplify the introduction or make it easier for a paper bag, for example, to be fitted over, and which bead-like portions simultaneously protect said paper bag; for this purpose, the bead is upwardly tapered and is rounded at the surface over which the paper bag that is to be pulled over slides.

To support the bearing of the articles against the lower container wall of a “heeled” order-picking container, a wedge may be arranged in the main body such that the acute-angled side of the wedge is arranged on that side of the main body which has the lowest point or the lower edge at the container margin that delimits the opening.

Such a wedge may also be arranged in a “normal” order-picking container, the main body of which extends vertically, in order, when the order-picking container is set upright again after the transfer of the articles, to prevent the undesired opening of the goods that are critical in terms of packaging. Said wedge advantageously prevents tilting or sliding of the articles in the order-picking container also during the further transport through the installation. Here, too, the acute-angled side of the wedge is arranged on that side of the main body which has the lowest point at the container margin, because this is the “lower” container wall when the order-picking container is, for the transfer of the articles, tilted toward the supply apparatus.

The wedge may preferably be composed of an elastically shock-damping material, for example a foam, in order to dampen the impact of the introduced articles and hold the edge of the lid with stabilizing action.

The order-picking container itself may be composed of a frame of flexurally rigid material, which is lined with walls and base panels which may be composed of wood, plastic, metal or other suitable panel materials. It may however also be an integrally cast body, the shape of which also comprises the “introduction aids” (bead portions), such that only the rollers together with fastenings thereof have to be attached as separate parts.

Further embodiments and some of the advantages associated with these and with further embodiments will become clear and better understandable from the following detailed description with reference to the accompanying figures. Objects or parts thereof which are substantially identical or similar may be denoted by the same reference designations. The figures are merely a schematic illustration of one embodiment of the invention.

Further embodiments of the method and of the apparatuses and some of the advantages associated with these and with further embodiments will become clear and better understandable from the following detailed description with reference to the accompanying figures. Objects or parts thereof which are substantially identical or similar may be denoted by the same reference designations. The figures are merely schematic illustrations of one embodiment of the invention.

In the figures:

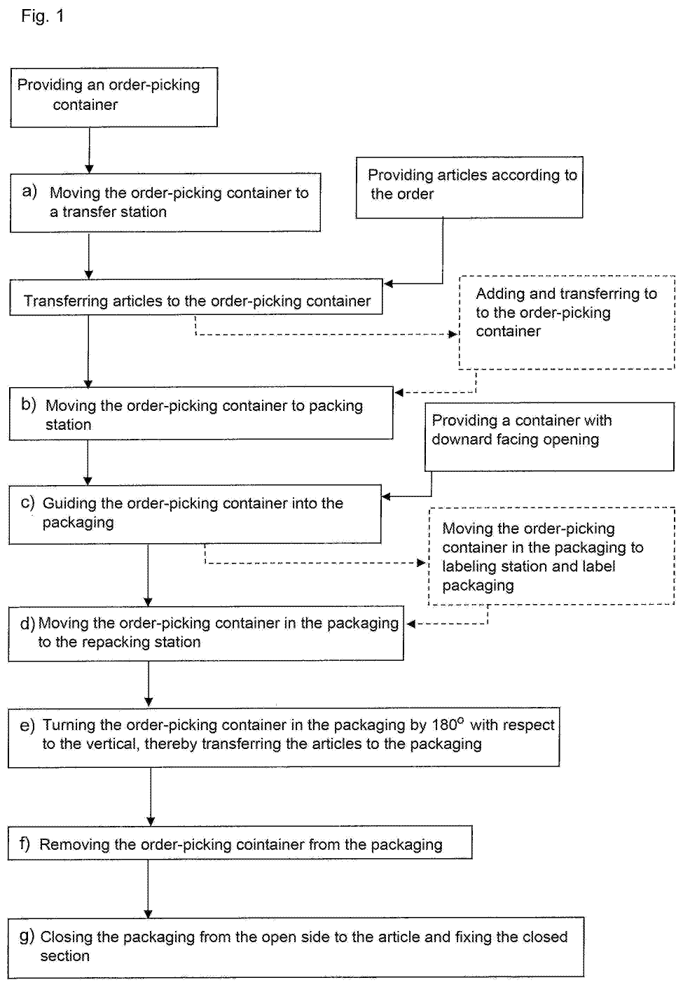

FIG. 1 shows a method schematic,

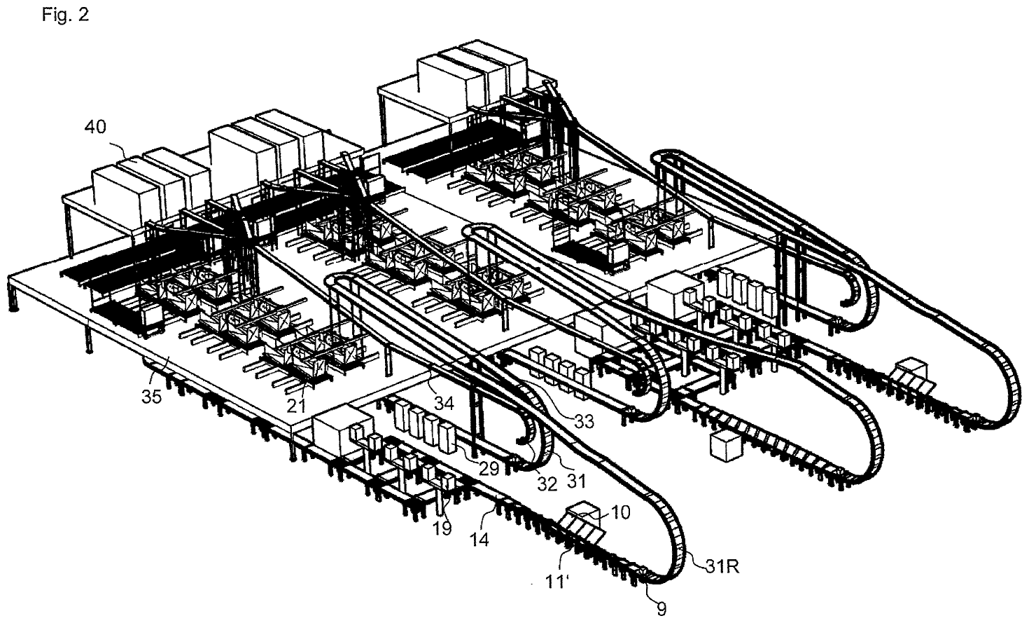

FIG. 2 shows a perspective view of an embodiment according to the invention of the order-picking and packing installation for orders composed of exactly one article,

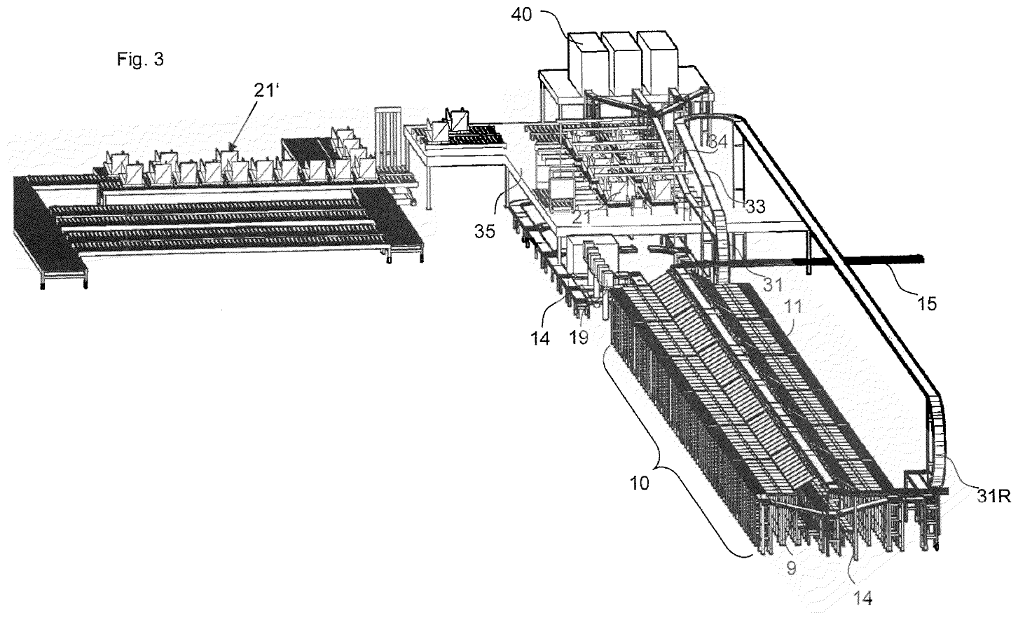

FIG. 3 shows a perspective view of an embodiment according to the invention of the order-picking and packing installation for orders with more than one article,

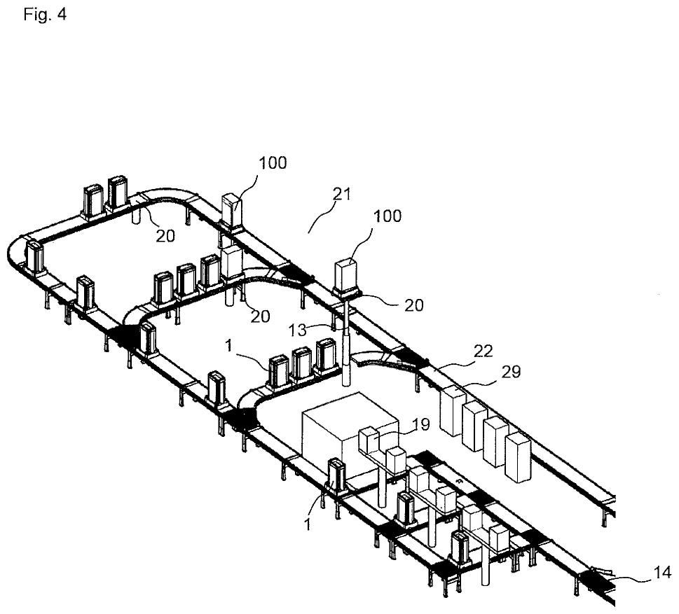

FIG. 4 shows a perspective view of a section of an order-picking and packing installation with additional-material, packing and labelling stations,

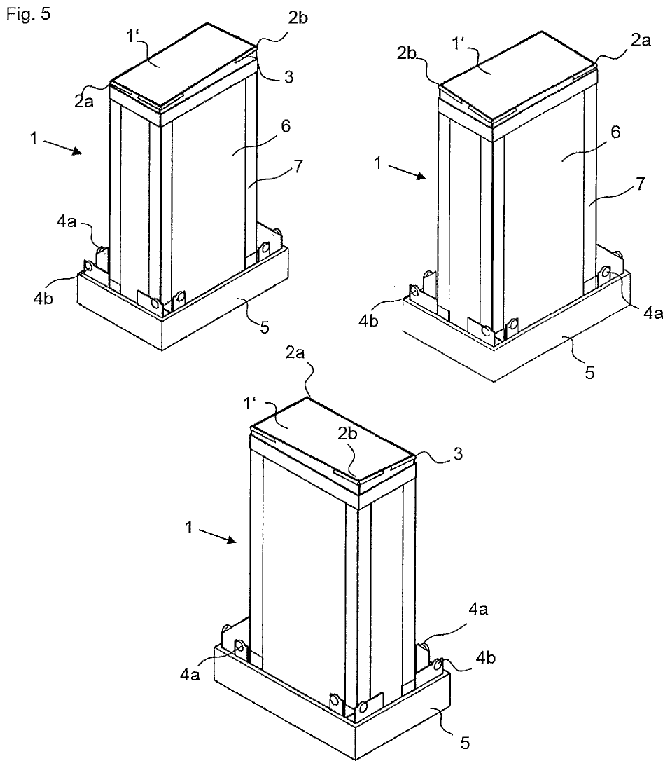

FIG. 5 shows three perspective views of an embodiment according to the invention of the order-picking container,

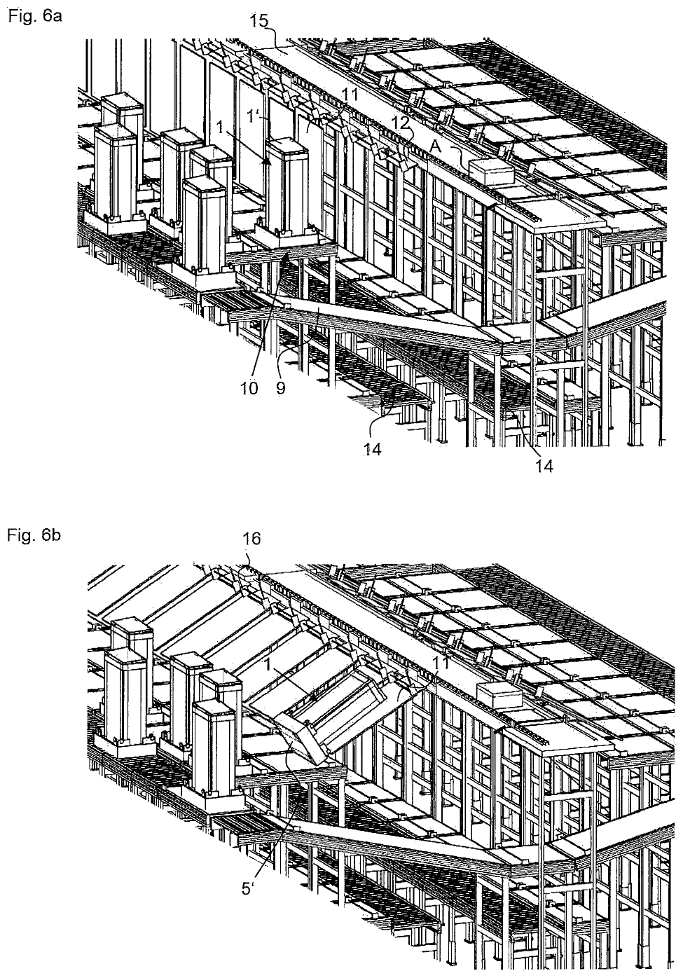

FIG. 6 shows two perspective views of an embodiment according to the invention of a transfer station with an order-picking container a) at a transfer location and b) in an inclined transfer position,

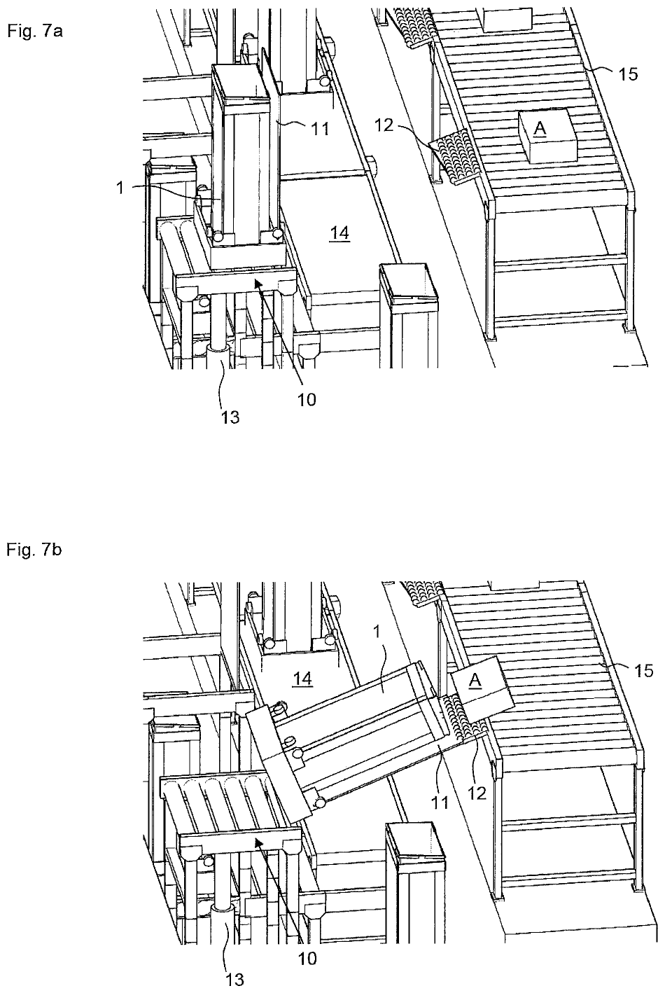

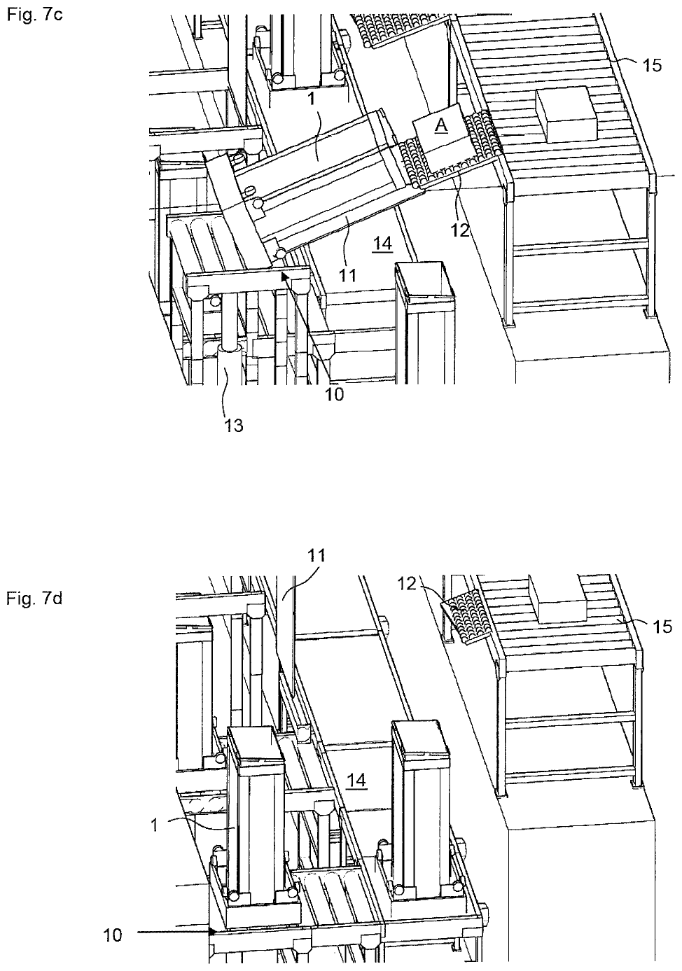

FIG. 7 shows four perspective detail views of a transfer station according to the invention with a) an arrival of the order-picking container at the transfer location, b) a movement of the order-picking container into the inclined transfer position, c) a transfer of an article, and d) a lowering of the filled order-picking container at the transfer location into an onward-transport plane,

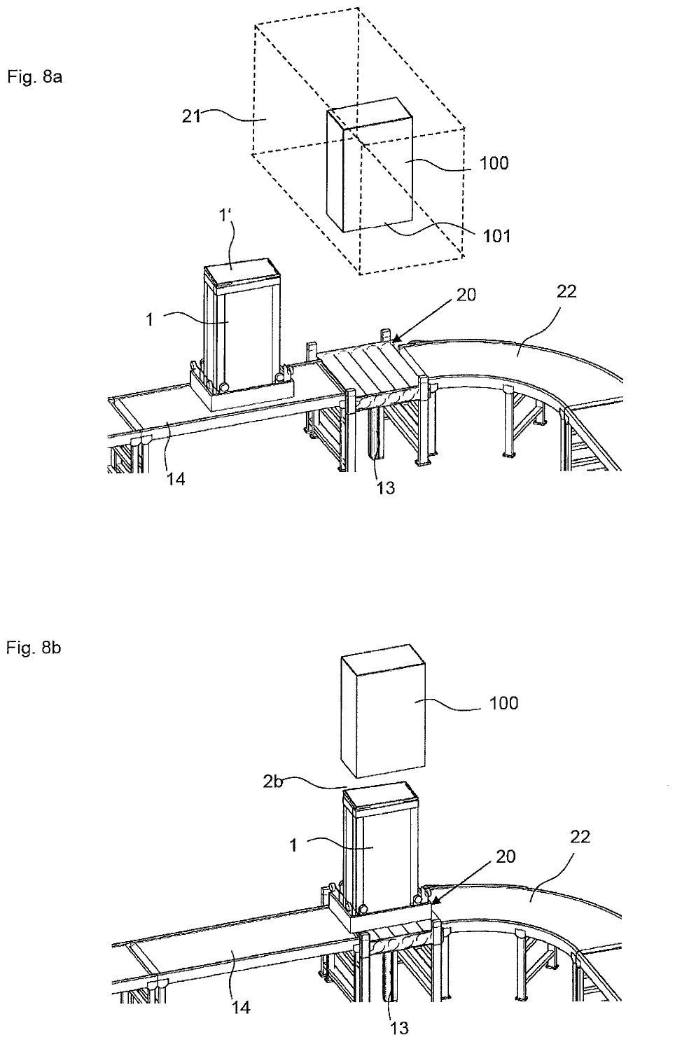

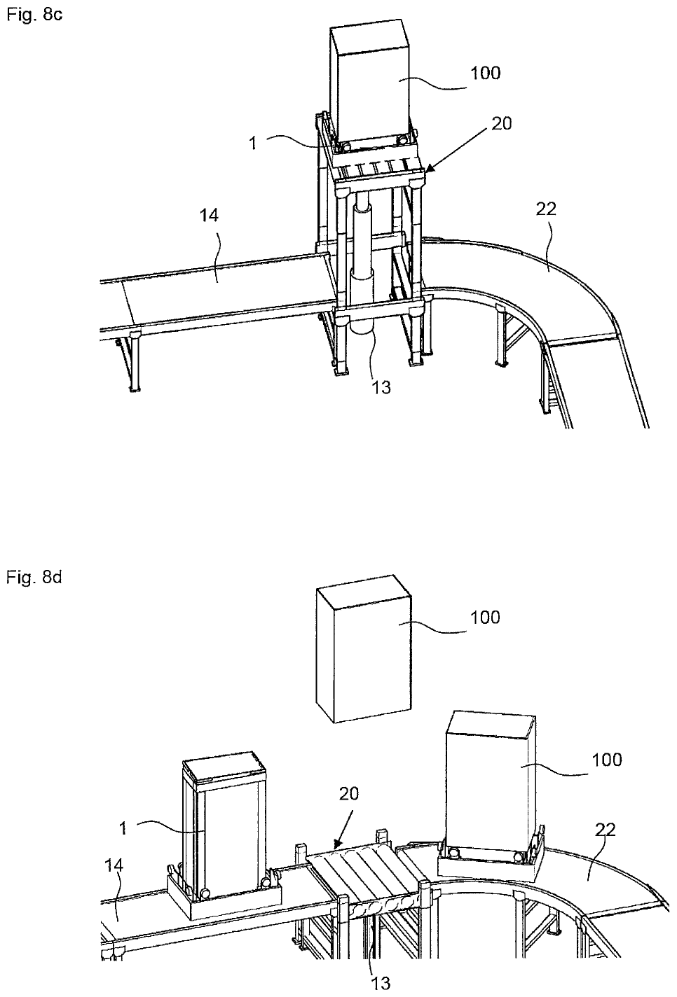

FIG. 8 shows four perspective views of an embodiment according to the invention of a packing station with a) an arrival of the filled order-picking container and provision of the bag, with opening downward, above the packing location of the order-picking container, b) a filled order-picking container at the packing location, c) a movement of the filled order-picking container upward into the opened bag, and d), after a lowering of the packing location, onward transport of the bagged order-picking container,

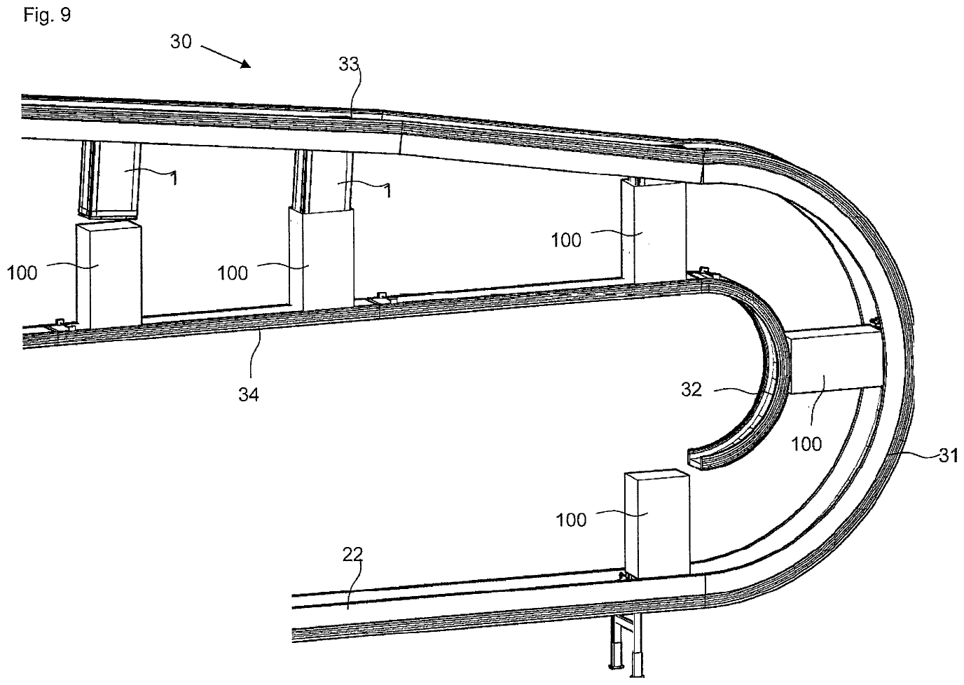

FIG. 9 shows a perspective view of an embodiment according to the invention of a retransferring and separating station,

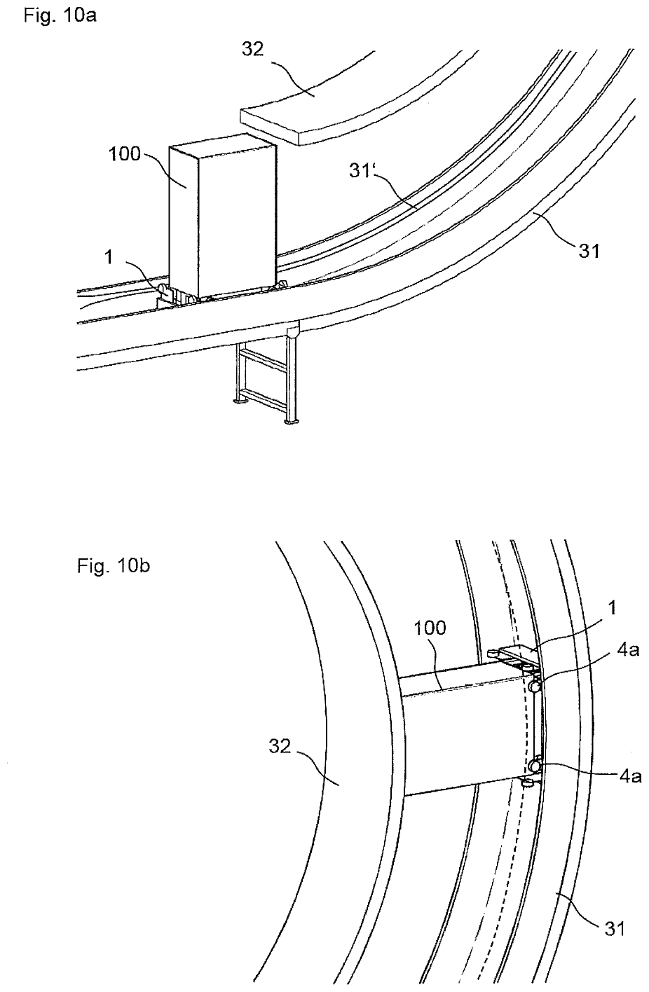

FIG. 10 shows perspective views of details of the retransferring and separating station from FIG. 9 with a) entry into the half-loop, b) transport through the half-loop with guidance of the bag base for the purposes of retransferring, and c) removal of the emptied order-picking container and onward transport of the filled bag,

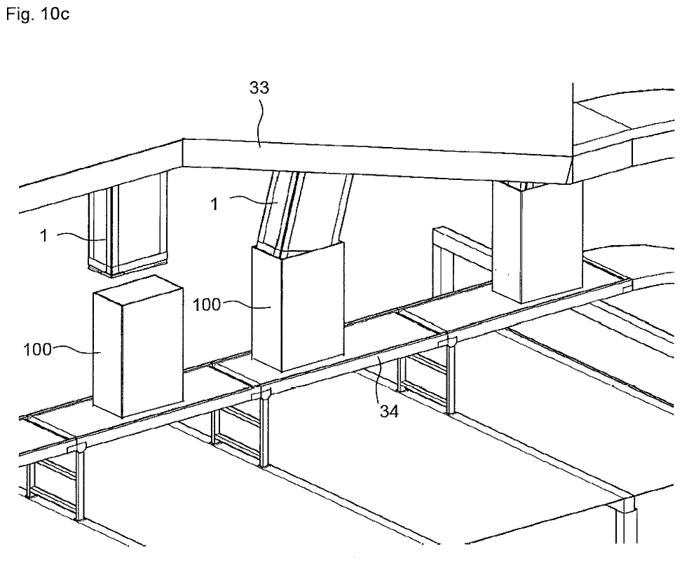

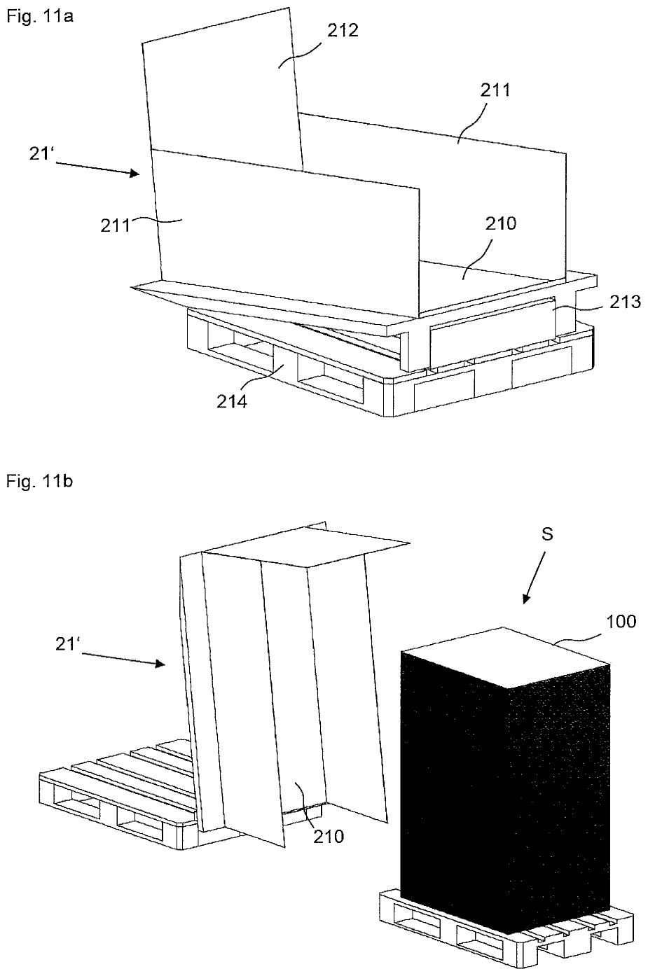

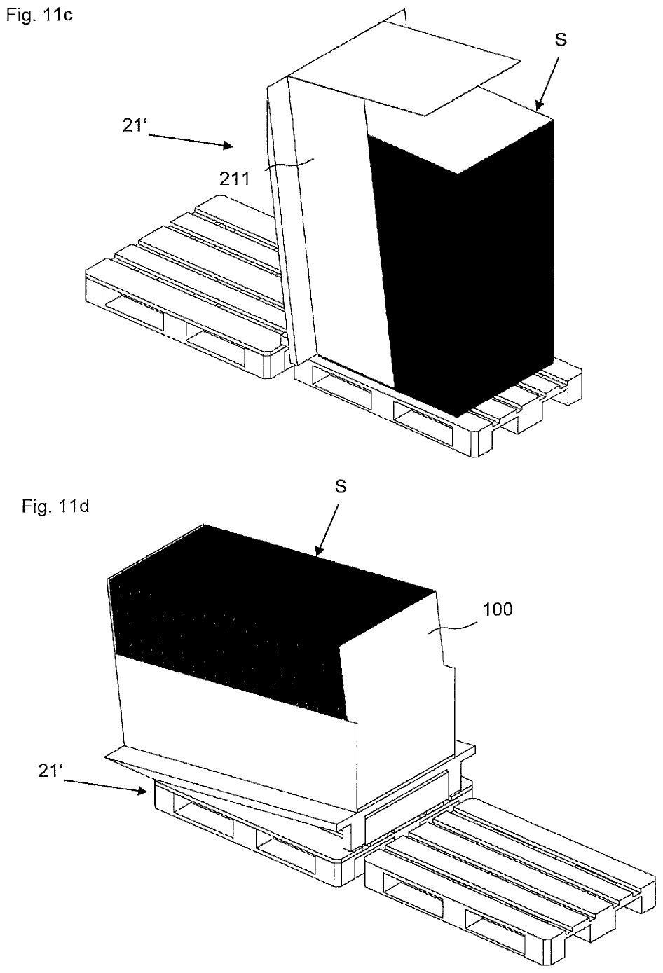

FIG. 11 shows perspective views of a cassette carrier of an apparatus for providing the transport packaging a) in an initial position, b) in a receiving position for receiving a packaging stack, c) with a received stack, and d) in a tipped-over position for the provision of the transport packagings,

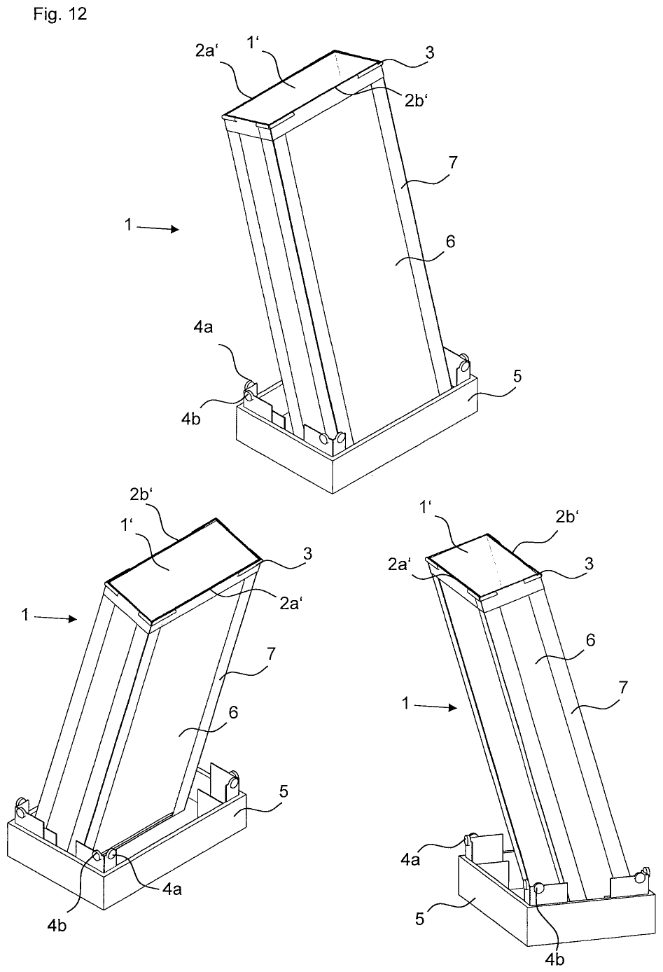

FIG. 12 shows three perspective views of a further embodiment according to the invention of the order-picking container,

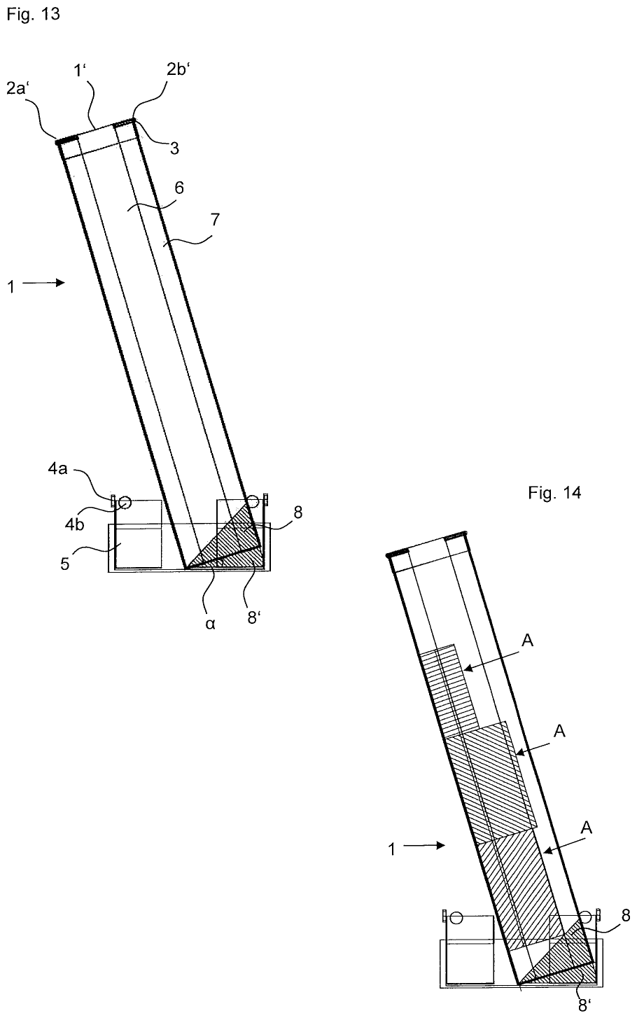

FIG. 13 shows a side view through the unfilled order-picking container from FIG. 12,

FIG. 14 shows a side view through the order-picking container from FIG. 12 filled with articles,

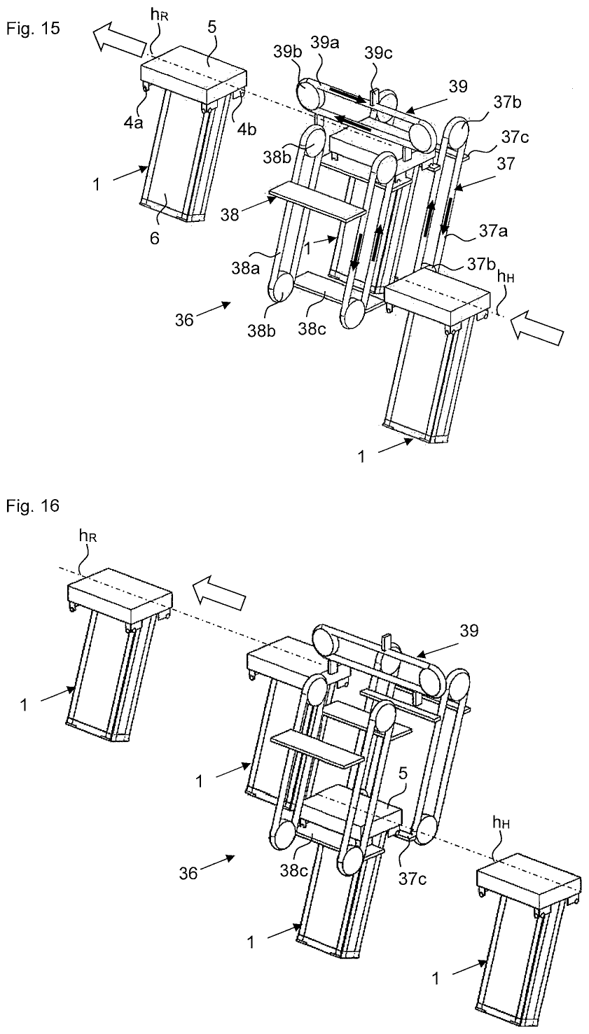

FIG. 15 shows a perspective view of an alternative separating apparatus with a turned order-picking container in an onward transfer position,

FIG. 16 shows a view corresponding to FIG. 15 of the separating apparatus with an order-picking container in a receiving position,

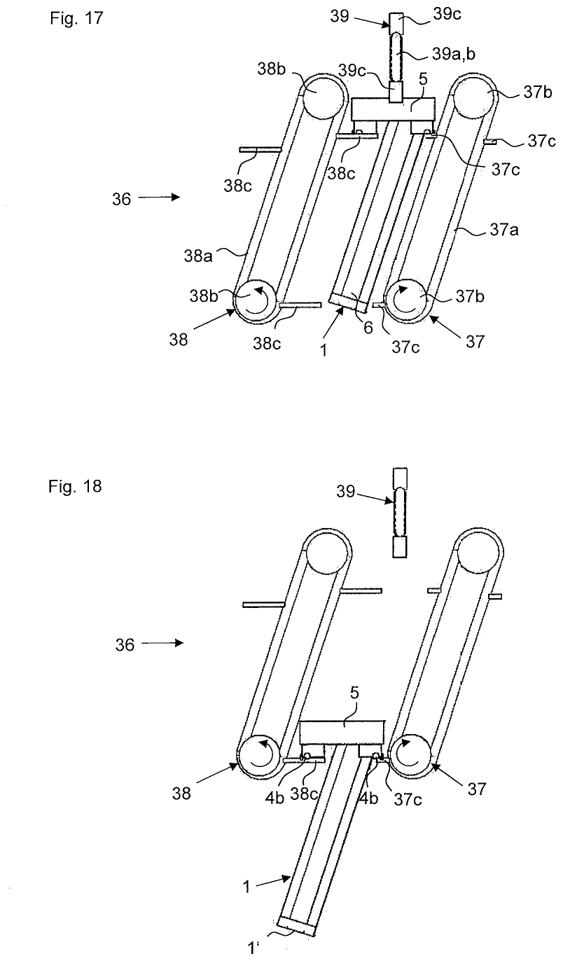

FIG. 17 shows a side view of the separating apparatus corresponding to FIG. 15,

FIG. 18 shows a side view of the separating apparatus corresponding to FIG. 16,

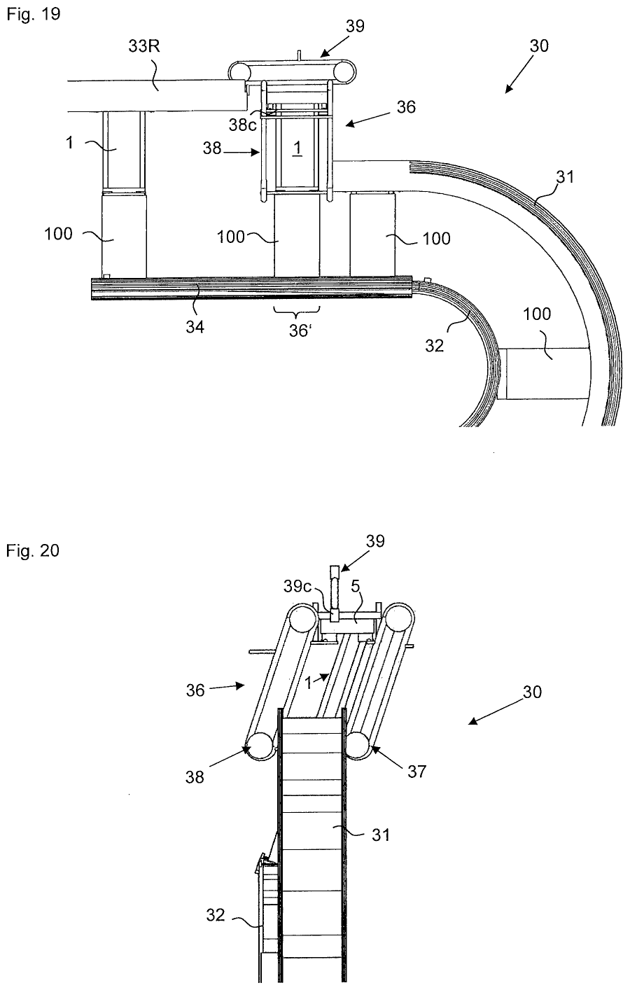

FIG. 19 shows a front view of a retransferring-separating station with the alternative separating apparatus,

FIG. 20 shows a side view of the retransferring-separating station from FIG. 19,

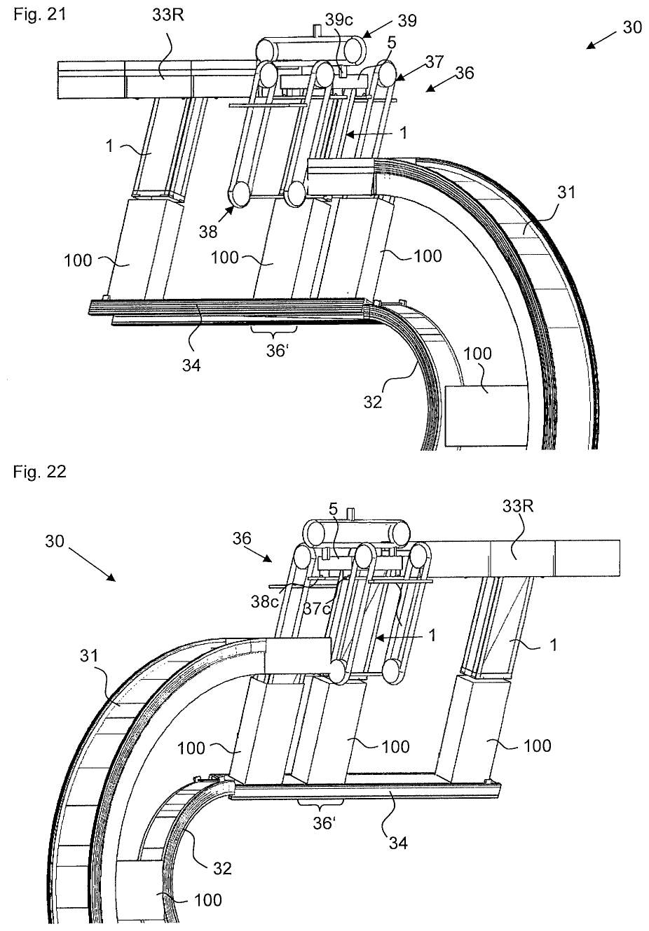

FIG. 21 shows a perspective view of the retransferring-separating station from FIG. 19 with an order-picking container in an onward transport position, and

FIG. 22 shows a perspective rear view of the retransferring-separating station from FIG. 21,

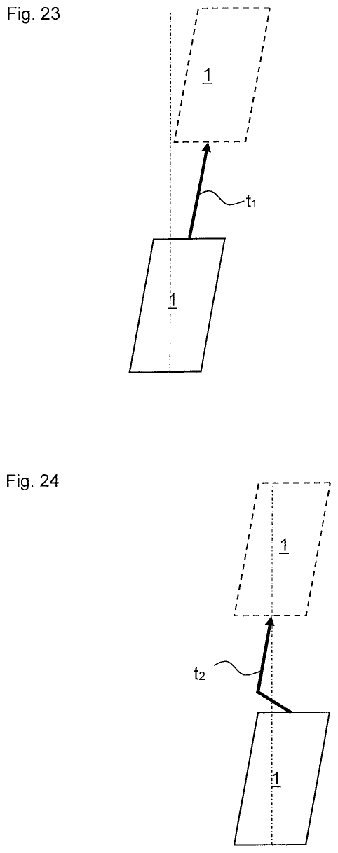

FIG. 23 is a schematic illustration of an oblique upward movement of a “heeled” order-picking container at the packing location,

FIG. 24 is a schematic illustration of a zigzag-shaped upward movement of a “heeled” order-picking container at the packing location.

The invention relates to a method for the automatic, consolidated order-picking and packaging of articles for shipment, to an order-picking and packing installation by means of which the method can be performed, and to an order-picking container which is suitable for use in said installation for carrying out the method.

FIG. 1 shows a flow diagram of the method according to the invention in which the optional steps of a particularly advantageous embodiment are indicated by means of dashed lines.

FIG. 2 shows an overall installation composed of three order-picking and packing installations according to the invention, which operate in parallel, for single-item orders, that is to say orders composed of only one article. The transfer location 10 at which each article is transferred in accordance with the order into an order-picking container is provided in this case by a tilting portion 11′ between the conveying devices 9, 14, which permits “twisting” conveying of the order-picking container, wherein said order-picking container is moved from a vertical transport direction into an “inclined” transfer position in order to allow the article to slide in smoothly. In accordance with cyclic operation, it is possible here for a defined throughput time to be defined. The transfer location 10 is followed by an additional-material station 19 for documentation and advertising media (as additional material by way of example; it is however also possible for small “gifts” of some other type for the recipient to be provided as additional material), from which the order-picking containers are conveyed below the platform 35 to the one or more packing locations. Situated on the platform 35 are the apparatuses 21 for providing the transport packagings, for the purposes of providing, at each packing location, a set-up transport packaging, with the opening pointing downward, above an order-picking container arranged there. It is possible here to see cassette carriers with different packaging formats of a magazine apparatus, which is part of the apparatus 21. After passing through the half-looping track 31 for the retransferring of the article into the transport packaging and after the order-picking containers have been separated from the transport packagings by means of the ramp 33, said transport packagings can be fed via the conveyor track 34 in each case to an apparatus 40 for closing the transport packaging. The emptied order-picking containers are, via a return turning apparatus 31R, provided to the transfer location 10 again for the order-picking of the next order.

FIG. 3 shows an order-picking and packing installation according to the invention, in this case with a transfer station with multiple transfer locations 10 for multi-item orders, wherein the articles of an order are transferred into the order-picking container, which is provided in an inclined configuration at a transfer location, before the further stations are passed through as in FIG. 2. Additionally, FIG. 3 also illustrates an installation section with a multiplicity of cassette carriers 21′, in which the various transport packagings are provided and the cassette carriers of the magazine apparatus are filled. Furthermore, it is possible here for breakage management of the transport packagings, including batch tracking of the packagings, to be implemented, which is performed for quality control reasons for fully automatic operation, because the detection of quality defects in the ongoing process, for example tearing of the packaging during the setting-up process, would be disadvantageous.

FIG. 4 shows, by way of example, an installation section with additional-material station 19, packing station with three parallel packing locations 20, and labelling station 29. The installation section with the packing locations 20 is, in the illustrations in FIGS. 2 and 3, concealed by the platform 35 under which said stations are arranged. It is self-evident that an order-picking and packing installation according to the invention is, with regard to the number of processing stations that operate in parallel (transfer stations, additional-material stations, packing stations, labelling stations, retransferring and separating stations and closure stations), and the number of processing locations provided in parallel or in series there (transfer locations, additional-material locations, packing locations and labelling locations), in no way restricted to the examples illustrated in the figures. It is self-evident that the installation may be designed variably in terms of the installation components as required.

The installations from FIG. 2 and FIG. 3 may be included adjacent to one another in an overall installation and may be operated in parallel as required depending on the order situation, wherein the orders with only one article are processed in the installations as per FIG. 2, whereas the multi-item orders are processed in the installation in FIG. 3. In the presence of a relatively low number or density of orders, it is also possible for the single-item orders to be processed in the installation from FIG. 3, which is then cheaper than also keeping the installation as per FIG. 2 in operation.

The method that can be carried out with such an order-picking and packing installation according to the invention provides the provision of a suitable order-picking container 1, as is shown by way of example, in each case in three views, in FIG. 5 or FIG. 12. In the order-picking container 1, the one or more articles are compiled in accordance with an order in order to be packaged for shipment.

The order-picking container 1 in FIG. 5, which in this exemplary embodiment has a substantially cuboidal main body 6, has, owing to trapezoidal wall surfaces at right angles, an opening 1′ which is inclined in relation to the base surface 5′ (see FIG. 6b), such that the container margin has a lowest point 2a and a highest point 2b, which forms a guide corner which, together with the roundings 3 at the corners, facilitates the insertion into the transport packaging 100. To increase the standing stability or reduce the risk of tipping of the main body 6, the height dimensions of which greatly exceed the width and depth dimensions, the main body 6 is arranged in a trough 5, the support surface of which is larger than that of the main body 6. Said main body is fastened in the trough 5, preferably detachably, for example by means of screws, in order to be able to exchange individual components as required. It is however also conceivable for the trough 5 and main body 6 to be formed as a single piece. Furthermore, the order-picking container 1 has longitudinal rollers 4a laterally in the vicinity of the base, and in the illustrated example also has transverse rollers 4b, which contribute to reliable guidance in a stable horizontal conveying process. Together with the trough 5, said rollers contribute, in particular in the presence of different loading/filling states in relation to the respective center of gravity, to reliable guidance during horizontal conveyance, in order to prevent tipping of the order-picking container 1. In the example illustrated, the rollers 4a, 4b are fastened to a frame 7, which also delimits the main body 6. Alternatives are however readily also conceivable in which the rollers 4a, 4b are fastened to the trough 5 or to the main body 6 itself. By contrast, in the variant with the frame 7, the main body 6 does not need to be in the form of a single piece, and may also be formed from panels that are fastened to the frame.

Rollers situated so as to face away from one another, that is to say either longitudinal rollers 4a or transverse rollers 4b, preferably the longitudinal rollers 4a, serve for conveying the order-picking container 1 in lateral rails for turning and overhead conveyance.

FIG. 12 and also FIGS. 13 and 14 show an alternative embodiment of an order-picking container 1 according to the invention, which differs from that in FIG. 5 primarily in that the main body 6 is inclined by an angle α with respect to the standing or base surface 5′, which is defined by the trough-like stabilizing apparatus 5. Owing to this inclination, the cuboidal main body 6 has a lower edge 2a′ and a higher edge 2b′ at the container margin that delimits the opening 1′, which opening is thus likewise inclined in relation to the (standing) base surface 5′ of the order-picking container 1. To fix and stabilize this inclination, a chock 8′ is provided, as can be seen in FIGS. 13 and 14, by means of which the main body 6 is fastened in the trough 5. Through suitable material selection with regard to the mass, it is also possible for the tipping moment of the “heeled” order-picking container 1 to be counteracted by means of said chock 8′. To stabilize the main body 6 in the trough 5, it is also possible for further support elements (not illustrated here) to be provided.

FIGS. 13 and 14 also show a wedge 8, which is preferably manufactured from foam material and which is arranged in the main body 6 on the inner base thereof, wherein the acute-angled side of the wedge 8 is arranged on that side of the main body 6 which has the lower edge 2a′ at the container margin that delimits the opening 1′. The foam wedge 8 assists, as can be seen in FIG. 14, the bearing of the articles A against the “lower” container wall of the “heeled” order-picking container 1, dampens the impact of the introduced articles A, and furthermore holds the edge of the lid of the lowermost article A with stabilizing action.

It is self-evidently also possible for a non-“heeled” order-picking container to be equipped with a foam wedge of said type in the main body in order, when the order-picking container is set upright again after the transfer of the articles, to reduce the undesired opening of the goods with loose lids and also reduce tipping or sliding of the articles in the order-picking container during the further transport through the installation. In this case, too, the acute-angled side of the wedge is arranged on that side of the main body which has the lowest point at the container margin, because this is the “lower” container wall when the order-picking container is, for the transfer of the articles, tilted toward the supply apparatus.

In the method according to the invention, which is shown in FIG. 1, each article A from the order is transferred, at a transfer location 10 (see FIGS. 2, 3, 6 and 7) predetermined for the article A or the respective order-picking container 1, from a supply apparatus 15 into the order-picking container 1. In order to allow this transfer to take place smoothly, in step a), the order-picking container 1 which has been conveyed to the predetermined transfer location 10 by means of conveying-in devices 9 is, as illustrated in FIGS. 6a and 7a, tilted with its opening 1′, preferably by way of that wide side thereof which has the highest corner point 2b, in the direction of the article supply apparatus 15, as shown in FIGS. 6b and 7b, such that the corresponding article A can, as shown in FIG. 7c, slide via the transfer apparatus 12 into the order-picking container 1. By contrast to the illustration, the order-picking container 1 may however also be tilted by way of any other side.

For the tilting of the order-picking containers 1, the transfer locations 10 of the transfer station of an order-picking and packing installation according to the invention each have an associated tilting ramp 11, which, at a predetermined inclination angle, connects a plane of the transfer location 10 to a plane, situated thereabove, of the supply apparatus 15 for the articles A. In the embodiment shown in FIG. 7, the transfer apparatus 12 of the supply apparatus 15 supplements the tilting ramp 11, which supports the order-picking container 1 at the predetermined inclination angle and sets said order-picking container upright again after a transfer of articles has taken place.

The embodiments of the installations and apparatuses according to the invention illustrated in FIGS. 2 to 4 and 6 to 11 are designed for order-picking containers 1 as per the embodiment shown in FIG. 5. The modifications to said installations and apparatuses that are correspondingly required for “heeled” order-picking containers 1 as per FIGS. 12 to 14 are however obvious. A transfer station for “heeled” order-picking containers 1 may in this case correspond to the statements above, wherein only the tilting ramp is adapted in terms of its tilting angle in order that the main body of the “heeled” order-picking container has, at the transfer location, the desired inclination with respect to the supply apparatus or transfer apparatus. If the inclination of the main body of the heeled order-picking container corresponds to the predetermined inclination angle for the transfer of the articles, the transfer station can omit tilting ramps.

The transfer apparatus 12 in the embodiment shown in FIG. 6 furthermore has a sensor apparatus 16, in this case a light barrier sensor, wherein the “light barrier” is illustrated symbolically as a line. Said sensor apparatus 16 is provided primarily for confirming a completed filling process, though may also be used as an overfilling monitoring means. For example, if more than one article is to be compiled in the order-picking container 1 and said articles include one or more bulky articles, it may be the case, if said articles A are in an unfavorable position in the order-picking container 1, that there is a protruding length of the article A beyond the opening 1′ of the order-picking container 1. Said protruding article can then be detected by means of the sensor apparatus 16 such that, in the event of a protruding length being detected, the controller causes the order-picking container 1 to be set into a vertical position from the inclined transfer position in order, by means of this movement, to rearrange the articles in the order-picking container 1 and allow the protruding article 8 to slide completely into the order-picking container 1. If yet further articles are then to be transferred into the order-picking container 1 in order to complete the order, said order-picking container is tilted again until the complete filling with all articles according to the order has been completed. If, upon renewed tilting of the order-picking container 1, the sensor 16 responds again owing to the continued presence of a protrusion without further articles having been transferred, the filling is terminated and a corrective action is automatically initiated or an error message for manual resolution by an employee is automatically output.

Depending on the nature of the order-picking, it is duly conceivable for an order-picking container 1 to be able to be conveyed to other transfer locations 10 for the transfer of other articles from the order, though provision is primarily made according to the invention for said order-picking container to receive all, even different, articles of an order at one transfer location 10. The order-picking container 1 assigned to an order remains at a transfer location 10 until all of the articles assigned to it or to the order have been sorted and discharged by the transfer apparatus. This is a further feature of the dynamic utilization of a closed container conveying circuit which, as a collecting point or “consolidator”, is repeatedly brought to the corresponding transfer locations, wherein each order-picking container is usable at all times and universally. For assignment, the order-picking containers are equipped with unique identifying features that can be detected automatically by means of a corresponding read unit, such as barcodes or QR codes or RFID transponders, wherein the corresponding barcode/QR code or RFID reader stations are integrated at all transfer locations and/or conveyance-relevant decision positions, such that the corresponding information regarding the order-picking container identity and the dynamic order identity can be utilized for control purposes at the transfer locations, the additional-material stations for delivery notes, invoices, flyers etc., the packing locations, and the labelling stations.

After all of the articles A have been compiled in the order-picking container 1, the latter is, in the illustrated embodiment of the order-picking and packing installation, moved downward by one level at the transfer location 10 by means of a lifting apparatus 13, and is transported onward there by means of the conveying device 14 to the packing station, as illustrated in FIG. 7d).

As indicated in FIG. 1 as an option, and illustrated in FIG. 4, the order-picking container 1 filled with the one or more articles according to the order may, prior to the packing station, pass through an additional-material station 19 for predetermined additional material, which, depending on desires and requirements, may be composed of delivery notes, invoices, flyers or else sample packagings, which additional-material station is arranged along the conveying devices 14. (In the illustrated example, three parallel additional-material stations 19 are illustrated, though it is also possible for more or fewer additional-material stations to be provided). The addition of the documentation or advertising media may be performed in automatically controlled fashion, wherein order-specific accompanying documentation such as delivery notes and invoices can be printed online by means of a printer apparatus (not illustrated) of the additional-material station 19 and automatically transferred in a “revolver arrangement” into the order-picking container 1 at a constant working level in order to thus achieve break-free operation, that is to say without an interruption to the process. A “revolver arrangement” means alternate operation of two (or more) apparatuses, wherein one apparatus is in a position which constitutes a “productive” working position, in which the printing of the documentation and dispensing of the documentation into the order-picking container under the action of gravity is performed, whilst the order-picking container remains bound to the cycle. If it is detected that there is a present demand for paper or toner or there is a technical fault in the apparatus in the “productive” working position, the apparatus that is thereupon situated in the “passive” rest position is moved by motor action into the “productive” working position by being rotated or turned, such that operation can be continued without interruption whilst the employee has access to the apparatus that is now situated in the rest position, wherein the rest position is situated outside the automated region that is protected by means of a corresponding housing. The employee can thus make the apparatus, which is to be filled or repaired, ready for use again.

As a next method step b), the order-picking container 1 filled with article(s) and possibly with the additional material is moved to a predetermined packing location 20, which is illustrated in one embodiment in FIG. 4—three parallel packing locations 20 are shown there—and in FIG. 8 in an image sequence a) to d). Above the packing location 20, a transport packaging 100 with a downwardly pointing opening 101 is provided by an apparatus 21 (illustrated schematically by dashed lines in FIG. 8a), which opening is dimensioned to receive the order-picking container 1. In FIG. 8b), the order-picking container 1 is arranged on the packing location 20, above which a transport packaging 100, set up and with the opening 101 pointing downward, is provided.

The apparatus 21 for providing the transport packaging 100 has a magazine apparatus with compartments for transport packagings 100 with different formats and furthermore a selection apparatus for selecting and isolating in each case one transport packaging 100 of a predetermined format, and a setting-up and holding apparatus for the unfolded transport packaging 100. The transport packaging 100 with a particular format is thus selected in accordance with a specification which is defined by a quantity/a volume of the articles of the order.

The magazine apparatus may comprise a folding mechanism and provide the various formats in a type of cassette carrier. The transport packagings of one format are commonly folded together as a stack by the supplier and delivered in a horizontal arrangement. To provide individual packagings from said stack, the cassette carrier has a receptacle for receiving the stack from the horizontal, folded-together transport packagings. By means of the folding mechanism of the magazine apparatus, the cassette carrier can be pivoted, such that the folded-together transport packagings are then present in an upright or substantially vertical arrangement, such that a single transport packaging can be more easily removed from the stack by means of an isolating apparatus. The apparatus 21 is designed to automatically dispense the packaging formats from the magazine apparatus with variable format provision in order to cover the various order sizes. Here, it may be preferable for the transport packagings 100 to differ only in terms of their height, but for the format of the base area to remain identical, in order to simplify not only the setting-up of the transport packaging 100 in the apparatus 21—it is thus possible for order-picking containers 1 of a uniform size to be used. Only the transport packaging 100 is, with regard to its height, selected with respect to the order size, wherein the cross-sectional shapes/base areas of order-picking container 1 and transport packaging 100 are configured correspondingly.

FIG. 11 shows, in a), a pivotable cassette carrier 21′ which is designed to receive a stack S of folded-together transport packagings 100 lying one on top of the other (which are delivered as a stack S on a conventional pallet, see FIG. 11b) with a container composed of an inclined base 210 and two side walls 211 and a rear wall 212. At the open side, the highest point of the inclined base 210, the cassette carrier 21′ has an articulated connection 213, by means of which the inclined base 210 is connected to a pallet base 214. To receive a stack S, the container is pivoted such that the inclined base 210 is arranged upright, as can be seen in FIG. 11b). As shown in FIG. 11c), the stack S is received between the side walls 211, whereupon the container is pivoted back, such that the transport packagings 100 of the stack S are received upright in the container, as can be seen in FIG. 11d). Here, the approximately vertically arranged transport packagings 100 can, owing to the inclination of the inclined base 210, be supported on the rear wall 212, such that the stack S is also stabilized in this orientation in order to permit an automatic removal, by machine, of the foremost transport packaging 100 by means of an isolating or gripper apparatus. The pivotable cassette carrier 21′ can be moved with the pallet base 214 and is equipped with a suitable sensor arrangement, which is connected to the control apparatus of the installation such that the latter can detect and control the fill level and position of the respective cassette carrier. The control apparatus can thus, when a cassette carrier has been emptied, transport the order-picking containers that are to be packaged to a different packing location whilst the cassette carrier is equipped with a new stack of packagings. Alternatively, another cassette carrier equipped with packagings may be provided in good time in order to be promptly exchanged for an emptied cassette carrier, such that the packing location does not have to be taken out of service. The control apparatus may furthermore, if an empty state of a cassette carrier for transport packagings of a particular format is detected, ensure that, for the duration of the re-equipping with the particular format, said packing location is used to pack only orders for which a different packaging format, which is still in stock at said packing location, is provided.

The order-picking container 1, which constitutes a “negative mold”, so to speak, which moves into the set-up transport packaging 100, which constitutes the “positive mold”, ensures a reliable, constant working level. The height of the order-picking container 1 relative to the base surface may be selected such that a wide variety of different articles can be received during the compilation of an order. The variability of the transport packaging 100 relates to its (height) format, which is selected suitably for the compiled articles of each order.

Although it is possible for differently dimensioned order-picking containers 1 to be provided which can be selected and used in automated fashion in a manner dependent on an order size, wherein the apparatus for providing the transport packaging 100 can be automatically controlled so as to provide a correspondingly suitable packaging format, the use of a uniform order-picking container 1 is however preferable, since, in this way, constant working level conditions are ensured and thus very high process reliability is achieved in the automated addition of documentation etc., in additionally optional monitoring of protruding lengths, and in the introduction into the transport packaging in the packing station.

An embodiment of the order-picking and packing installation that is not illustrated in the figures may thus also have an optional monitoring apparatus for monitoring protruding lengths, which monitoring apparatus may be arranged along the conveying devices 14 between the additional-material station 19 and the packing station 20. In interaction with the monitoring apparatus, a sorting-out apparatus may be provided along the conveying devices 14, which sorting-out apparatus, in the event of a protruding length being detected at an order-picking container 1, moves said order-picking container onto a bypass conveying track which allows fault elimination. This may be performed automatically for example by means of a gentle shaking apparatus, such that the articles/the additional material are better positioned in the order-picking container 1 and no longer protrude. However, an intervention by an employee may possibly also be necessary before the order-picking container 1 is fed back to the conveying devices 14 that lead to the packing station 20.

In step c), which is shown in FIG. 8c and at the foremost packing location 20 in FIG. 4, the order-picking container 1 is introduced through the opening 101 into the transport packaging 100 by virtue of the packing location 20 being moved upward by means of a lifting apparatus 13. The introduction is facilitated by means of the guide corner 2b and the roundings 3 at the margin of the order-picking container 1. FIG. 8d) shows the onward transport of the order-picking container 1, with transport packaging 100 pulled over it, by means of conveying devices 22 which lead to the retransferring and separating station 30 (FIGS. 9 and 10), whilst the next order-picking container 1 is moved to the packing location 20 and a further transport packaging 100 is provided.

A packing station, not illustrated in the figures, for an installation according to the invention which utilizes “heeled” order-picking containers is modified in accordance with the requirements predefined by the inclination of the main body. By contrast to the embodiment shown in FIG. 4 and FIG. 8, which uses “normal” order-picking containers, it is possible in the case of a packing station for “heeled” order-picking containers 1 for the apparatuses for providing the transport packaging with a downwardly pointing opening to be arranged in a horizontally offset manner above each packing location, as is schematically illustrated in FIG. 23, and the respective lifting apparatus may be designed to perform a correspondingly oblique upward movement t₁, which is adapted to the inclination of the main body. The transport packaging is then provided in a correspondingly inclined manner by the provision device, such that the main body of the order-picking container can slide in a shock-free and crease-free manner into the transport packaging. As an alternative to this, the transport packaging may be provided duly in an inclined manner but vertically directly above the packing location, as is schematically indicated in FIG. 24, if the upward movement of the packing location follows for example a coordinated zigzag course t₂ in order to introduce the inclined main body into the transport packaging. However, the first variant may be preferred, because a rectilinear oblique movement is much easier to provide, whereas a lifting apparatus for a zigzag course is of more complex and cumbersome form.

For “heeled” and for “normal” order-picking containers, the lifting apparatus 13 may be provided for example by a lifting cylinder as can be seen in FIGS. 8a-d. To perform an oblique upward movement t₁ in the case of “heeled” order-picking containers, the lifting cylinder may be arranged obliquely in accordance with the inclination of the order-picking container.

Alternative lifting apparatuses are however also conceivable, which, according to the present understanding, is intended to include all apparatuses by means of which an order-picking container at the packing location can be lifted out of the plane of the conveying devices 22 into the transport packaging 100 provided above said plane. Lifting apparatuses according to the invention therefore also include, by way of example but not exclusively, lifting scissor mechanisms, elevator or lift apparatuses. An exemplary lift apparatus for lifting a “heeled” order-picking container will be described in conjunction with an alternative separating station on the basis of FIGS. 15-18, but in that case with an order-picking container that has been turned. The lift apparatus shown there, composed of two circulating conveyors, which are designed similarly to paternoster elevators, is however readily transferable to use as a lifting apparatus for an order-picking container at a packing location.

As the filled order-picking container 1 arranged in the transport packaging 100 is conveyed by means of the conveying devices 22 to the retransferring and separating station 30 in method step d), the filled order-picking container 1 arranged in the transport packaging 100 may pass through a labelling station 29 (see FIG. 2 and FIG. 4), which in the examples shown has four labelling apparatuses, the number of which may however by all means differ, such that the transport packaging 100 can be equipped with a shipping label, which can be stuck on automatically. In the labelling apparatus, the shipping data according to the order are normally printed online by a thermal printer onto the labels, provided from a label roll, composed of thermally sensitive paper, are detached from the roll and applied to the packaging. The number of labelling apparatuses used is dependent on the designed throughput of the installation. In the example illustrated, two labelling apparatuses are required—the number of four apparatuses is in this case, and also in the case of the additional-material station, determined by the prerequisite of break-free automated operation. That is to say, two labelling apparatuses are situated in the working position and two are situated in the rest position, which are then automatically brought into use when the active apparatuses require replenishment of label rolls or develop other faults, which is then resolved by an employee.

Here, the label is applied to the transport packaging 100 at a location which is still clearly visible even after the subsequent closure of the transport packaging 100. It is therefore preferably possible for the label to be attached in the vicinity of the base of the transport packaging 100, which in the overturned arrangement on the order-picking container 1 corresponds to an upper section of the order-picking container 1. The labelling of the transport packaging 100 that has been pulled over the order-picking container 1 and stabilized by the latter is thus performed under constant and thus highly reliable process conditions at a working level in a constant working plane, before, in method step e), the retransferring of the one or more articles A from the order-picking container 1 into the transport packaging 100 is performed by means of a turning movement, preferably through 180° in relation to the vertical, in order to stabilize the transport packaging 100 until it is arranged upright with the opening pointing upward.

For the retransferring operation, the retransferring and separating station 30 has a turning apparatus which, in the present example in FIGS. 9 and 10, is composed of a half-looping track 31 for the order-picking containers 1 and a corresponding stabilizing track 32 for the base of the transport packaging 100 for the purposes of performing a 180° turn in relation to the vertical. Subsequently, to separate the now emptied order-picking container 1 from the transport packaging 100 as per method step f), a separating apparatus is provided, which lifts the order-picking container 1 out of the transport packaging 100, which, in one embodiment, is performed by virtue of the order-picking container 1 and the transport packaging 100 being guided and conveyed along tracks 33, 34 which diverge in relation to the vertical. In the example shown in FIGS. 9 and 10c, the order-picking container 1 is in this case guided along a rising ramp 33, whereas the transport packaging 100, which now contains the articles, is conveyed onward horizontally along the conveying track 34. The order-picking container 1 and the transport packaging 100 are thus dynamically decoupled, that is to say separated, by means of the synchronous conveyance along the ramp 33 or the conveying track 34. For a “heeled” order-picking container, a turning apparatus and a separating apparatus are adapted correspondingly: the half-looping track and the stabilizing track will be offset with respect to one another in accordance with the degree of inclination of the order-picking container, in order, during the turning movement, when the order-picking container follows the half-looping track, to stabilize the base of the transport packaging by means of the stabilizing track. The separating apparatus that follows is modified such that the order-picking container performs a movement along the inclination direction of its main body, such that the order-picking container is pulled rectilinearly out of the transport packaging without becoming stuck. For this purpose, the rising ramp of the separating apparatus may also be arranged so as to run in a diverging manner in a horizontal direction with respect to the conveying track of the transport packaging.

In order that the order-picking container 1 can be moved through the half-looping track 31 and along the ramp 33, corresponding guide means are provided there. In the example illustrated, these are lateral guide rails 31′ which, in this case, are designed to engage with the longitudinal rollers 4a of the order-picking container 1 for the conveyance thereof through the half-loop, because the order-picking container 1 is conveyed in the longitudinal direction in order to decrease the tipping tendency. At the entry to the half-loop, in FIG. 10a, it is possible to see a tapering run-in region of the rail 31′ for the rollers 4a. In FIG. 10b, the lateral guide has been partially omitted for the purposes of illustrating the longitudinal rollers, and the rest of the wall has been indicated by means of dashed lines.

As an alternative to the longitudinal guidance, it is however self-evidently also possible for such a half-looping track 21 and the ramp 33 to be designed for a transversely conveyed order-picking container 1, wherein the transverse rollers 4b then engage into the guide rails.

Not illustrated are further conceivable turning apparatuses for the retransferring of the articles from the order-picking container 1 into the transport packaging 100. For example, a helical coil would also be conceivable, such that the order-picking container 1 is rotated about two axes during the turning movement.

A refinement of the order-picking container 1 that is not illustrated may furthermore provide that this has an integrated pendular suspension means in order to prevent a jamming-free upward conveying movement in the ramp 33 during the movement out of the transport packaging 100, by virtue of the main body 6 of the order-picking container 1 being able to be held so as to be freely pendular in the horizontal during the upward movement.

As an alternative to the diverging tracks for the separation of the order-picking container 1 and the transport packaging 100, a retransferring and separating station 30 of an alternative embodiment as illustrated in FIGS. 19 to 21 may have a space-saving separating apparatus in the form of a lift apparatus 36 following the turning apparatus, which, in this example too, is composed of a half-looping track 31 for the order-picking containers 1 and a corresponding stabilizing track 32 for the base of the transport packaging 100 for the purposes of performing a 180° turn in relation to the vertical. As can be seen in FIG. 20, in this exemplary embodiment, which relates to “heeled” order-picking containers 1, the half-looping track 31 and the stabilizing track 32 are offset with respect to one another in a horizontal direction in accordance with the inclination of the “heeled” order-picking containers 1.

After passing through the turning apparatus, that is to say after exiting the half-looping track 31, the turned order-picking container 1, as will be described below in more detail and in conjunction with FIGS. 15 to 18, is engaged by the separating apparatus formed as a lift apparatus 36 and, in accordance with the inclination of the “heeled” order-picking container 1, is guided obliquely upward and thus separated from the filled transport packaging 100, which, during the separating phase, stops on a holding location 36′ along the conveying-away track 34 below the lift apparatus 36, and is conveyed away onward in the direction of the closure station only after the separation has been completed.

For the return of the turned order-picking containers 1, the upper end of the lift apparatus is followed by a return track 33R, into which the turned order-picking container 1 is transferred by means of a horizontal conveyor device 39. Via the return track 33R, the turned (and therefore empty) order-picking containers 1 can be fed to a return turning apparatus, such that they can then, again with the opening pointing upward, and after assignment to a new order, be fed to the transfer station with the transfer locations. The height difference that must be covered by means of the lift apparatus 36 is determined by the heights of the transport packaging 100 and of the order-picking container 1, whereby the positioning of the return track 33R and of the horizontal conveyor device 39 is determined.

The horizontal conveyor device 39, which can likewise be seen in FIGS. 15 to 18, is, in the example shown, a horizontally arranged circulating conveyor 19 composed of an encircling chain or a belt 39a, which is driven in a guided manner around two diverting rollers 39b. In FIG. 15, the black arrows indicate the circulating direction of the belt 39a, on which three driver or engagement elements 39c are arranged at uniform intervals. Depending on the conditions and requirements with regard to size and cycle time, it is also possible for more or fewer than three driver or engagement elements 39c to be provided. Here, as driver or engagement elements 39c, simple plate portions are provided which are fastened, perpendicularly with respect to the conveying direction, to the circulating belt 39a. The circulating conveyor 39 is arranged relative to the lift apparatus 36 and the return track 33R such that a turned order-picking container 1, which is received into the lift apparatus 36 at the height h_{H} of the half-looping track 31, is, upon reaching the height h_{R} of the return track 33R, pushed horizontally out of the lift apparatus 36 into the return track 33R by virtue of one of the driver elements 39c coming to bear against a wall portion, close to the base, of the order-picking container 1 or of the trough-like stabilizing apparatus 5 thereof, and driving the order-picking container 1 along in the conveying direction of the horizontal circulating conveyor 39. The speed of the horizontal circulating conveyor 39 is coordinated with the speed of the lift apparatus 36 in order to be able to convey an order-picking container that arrives at the onward transfer position at the height h_{R} onward in good time.

FIGS. 15 and 17, 19 to 22 each show an order-picking container 1 in the lift apparatus 36 in the onward transfer position at the height h_{R} for the onward transfer into the return track 33R.

FIGS. 16 and 18 show an order-picking container 1 which can be seen in the lift apparatus 36 in a receiving position at the height h_{H} corresponding to the exit of the half-looping track 31. The lift apparatus 36 is composed, in the example shown, of two circulating conveyors 37, 38 which, in accordance with the inclination of the main body 6, run in an inclined manner relative to the standing or base surface 5′ defined by the trough-like stabilizing apparatus 5, in order to be able to lift the “heeled” order-picking container 1 smoothly out of the transport packaging 100.

Each circulating conveyor 37, 38 is composed of a pair of chains or belts 37a, 38a which circulate in parallel and which are driven in a guided manner around in each case two diverting rollers 37b, 38b. In FIG. 15, the black arrows show the circulating direction of the belts 37a, 38a. On each belt pair 37a, 38a in each case three driver or engagement elements 37c, 38c are arranged at uniform intervals. Depending on the conditions and requirements with regard to size and cycle time, it is also possible for more or fewer than three driver or engagement elements 37c, 38c to be provided, although it is necessary for both circulating conveyors 37, 38 to have the same number of driver or engagement elements 37c, 38c, and the circumferential positions thereof must be coordinated with one another in order to be able to exactly receive the order-picking container 1 such that its main body 6 is moved parallel to the circulating conveyors 37, 38. For the illustrated order-picking container 1 with the trough-like stabilizing apparatus 5, on the margin of which the driver or engagement elements 37c, 38c engage, the circumferential positions thereof must be coordinated such that the driver or engagement elements 37c, 38c facing toward one another are situated opposite one another at the same height during the upward movement. For a different order-picking container, in the case of which, for example, the trough margin has different heights, or which provides different engagement means, it is also possible for circumferential positions of the respective driver or engagement elements 37c, 38c which differ from this to be provided in order to guide the main body 6 in a movement parallel to the circulating conveyors 37, 38.

As driver or engagement elements 37c, 38c, it is the case here, too, that plate portions are provided which are fastened, perpendicularly with respect to the conveying direction, to the circulating belt pairs 37a, 38a. Owing to the provided eccentric arrangement of the inclined main body 6 in the trough-like stabilizing apparatus 5, with which the driver or engagement elements 37c, 38c engage, the plate-like driver or engagement elements 37c of the circulating conveyor 37 close to the container are narrower than the plate-like driver or engagement elements 38c of the circulating conveyor 38 remote from the container, as can be clearly seen in particular in FIGS. 17 and 18. Here, “close to the container” and “remote from the container” refer to the spacing of the main body 6 to the respective circulating conveyor 37, 38.

By contrast to the illustration in FIGS. 15 to 22, with the lift apparatus 36 as separating apparatus, it is made possible for a return track to also follow in an opposite direction if the horizontal circulating conveyor 39 were operated in an opposite direction, and/or to directly follow the return turning apparatus.

Likewise not illustrated is a conceivable embodiment in which a lift apparatus is used in an installation for “normal” order-picking containers 1. By contrast to the illustrated lift apparatus 36, a lift apparatus for non-heeled order-picking containers will have circulating conveyors which convey in a vertically upward direction and which are spaced apart symmetrically from the main body and the driver or engagement elements of which may consequently be designed to be of equal width.

After the separation has been completed, the emptied order-picking container 1, after passing through a further turning apparatus, such that the opening 1′ of the order-picking container 1 points upward again, is assigned by the control apparatus to an order, and is moved to the transfer station again by means of conveying devices 9.

In order to be made ready for shipment, the transport packaging 100, in which the articles and possibly also the additional material are now situated, and which already has the shipping label, is transported to the closure station 40, where the transport packaging 100 is, without the addition of filler materials, closed proceeding from the opening side by being folded over or rolled up. For example, for this purpose, the closure station may have one or more folding apparatuses, beginning with an entry passage, in which the opposite sides of the transport packaging are brought together at the top at the opening and are possibly also pre-bent or preferably pre-kinked. For this purpose, the entry passage may for example be formed by a converging pair of rails or the like, which is supplemented by a profile rail in order to generate the desired pre-fold (or bend). This is followed by at least one further folding apparatus (or bending apparatus) in order, for the purposes of closing the transport packaging, to generate a folded turnover (or a rolled-up bend) proceeding from the opening side on the continuously onwardly conveyed transport packaging. In order to hold the articles in their transport packaging 100 so as to be prevented from slipping, the folding-over or rolling-up is performed as many times as necessary to achieve that the packaging volume is minimized in accordance with the content. The folding-over or rolling-up process is thus variable, but is dependent only to a small degree on the fill quantity or the fill volume, because the format of the transport packaging 100 can be selected in accordance with a quantity/a volume of the articles of an order in order to limit the number of folds required for securing the articles.

Thus, for example, provision may be made whereby different closure apparatuses are provided for the different formats of the transport packagings, which closure apparatuses differ in particular with regard to the positioning of the folding apparatuses in relation to the conveying track for the transport packaging. Accordingly, the height of the entry passage may be adapted to the height of the transport packaging. It is thus possible for different closure apparatuses to be operated in parallel in one closure station, wherein the assignment of the filled transport packagings to the correct closure apparatus in a manner dependent on the format of said transport packagings is performed in an automatically controlled manner. For example by means of a sensor arrangement (sensor arrangement refers in this case to one or more sensors) which detects the height of the transport packagings being conveyed past or the labels, from which the corresponding information regarding the assignment of the respective transport packaging can be determined. It is however basically also conceivable that the information required for the controlled assignment of the transport packagings to the correct closure station is obtainable even after the separation from the identifying feature of the order-picking container that the control apparatus can assign to the corresponding order and thus to the packaging format used, because the transport packagings exit the separating apparatus in the same sequence as the order-picking containers.

If provision is made for the number of folds to be variable and to be dependent on the fill height of the articles in the transport packaging, use may for example be made of a fill height sensor, such that the number of folding processes for each transport packaging is determined by means of the control apparatus, and the respective transport packaging is then transported by means of corresponding conveying apparatuses to the folding apparatuses required for transport packaging.

The folded-over portion is then fixed. This may be performed preferably by stitching or by means of a suitable double-sided adhesive tape, or else alternatively for example by means of hot adhesive bonding or tacking. The transport packagings may preferably be stitched, wherein the stitching station required for this purpose may be arranged so as to follow the folding apparatuses. The closure by stitching with automatic thread cutting may be performed by single-thread chain stitching, which makes subsequent opening easy for the recipient. Tacking as a fixing of the closure may also follow the folding process, but tacked closures are more difficult for the recipient to open and are therefore less preferred. Fixing by means of a double-sided adhesive tape or hot adhesive, as is likewise conceivable, is however less expedient in terms of process and installation technology, because the introduction of the adhesive tape or hot adhesive must be performed before the final folding process, such that, for this purpose, a corresponding apparatus would have to be incorporated between the folding apparatuses.

In the case of the closure station, too, as in the case of the packing station, the additional-material station (replenishment of toner/paper) and the labelling station (replenishment of label rolls), parallel apparatuses are provided such that, in the event of a fault or in the event of a need for replenishment or maintenance of an active apparatus, a hitherto passive apparatus automatically takes over the operation, wherein the switchover of the conveyance of the transport packagings to be closed is likewise performed automatically, whilst the adhesive tape or other adhesive material can be replenished by an employee in the other, now passive apparatus.

Altogether, the order-picking and packing installation according to the invention permits the use of extremely simple conveying and handling technology elements owing to only linear movements, and thus ensures extremely high installation/machine availability. The method according to the invention permits very high throughput dynamics—it is the intention, by means of suitable decoupling, to achieve a throughput of 10,000 parts per hour with stable process reliability.

### LIST OF REFERENCE DESIGNATIONS

1 Order-picking container
1′ Opening
2a, 2b Lowest, highest point of the container margin
2a′, 2b′ Lower, higher edge of the container margin
3 Rounding
4a, 4b Lateral longitudinal, transverse rollers
5 Stabilizing apparatus
5′ Base surface
6 Container main body
7 Container frame
8, 8′ Foam wedge, chock
9 Conveying device
10 Transfer location
11, 11′ Tilting ramp, tilting portion
12 Transfer apparatus
13 Lifting apparatus
14 Conveying device
15 Supply apparatus
16 Light barrier sensor
19 Additional-material location
20 Packing location
21, 21′ Transport packaging apparatus, cassette carrier
210, 211, 212, 213, 214 Inclined base, side wall, rear wall, joint, pallet base
22 Conveying device
29 Labelling station
30 Retransferring and separating station
31, 31′, 31R Half-looping track, guide rail, return turning apparatus, turning apparatus
32 Stabilizing track
33, 33R Rising ramp, return track
34 Conveying-away track
35 Platform
36, 36′ Lift apparatus, holding location
37 Circulating conveyor close to the container
37a,b,c Belt, diverting roller, narrow engagement element
38 Circulating conveyor remote from the container
38a,b,c Belt, diverting roller, wide engagement element
39 Horizontal circulating conveyor
39a,b,c Belt, diverting roller, engagement element
40 Closure station
100, 101 Transport packaging, opening
A Article
S Stack
t₁, t₂ Oblique upward movement, zigzag upward movement
α Angle of inclination of main body

What is claimed is:

1.-18. (canceled)

19. A method for automatic consolidated order-picking and packaging of articles (A) for shipment, wherein an order-picking container (1) is provided, in which articles (A) are collected in accordance with an order, the method comprising the steps of:
a) arranging the order-picking container (1) at a transfer location (10) of a transfer station and transferring at least one article (A) provided in accordance with the order into the order-picking container (1),
b) moving the order-picking container (1) filled with the at least one article (A) to a predetermined packing location (20) and, above the packing location (20), providing a transport packaging (100) comprising an opening (101) which is dimensioned to receive the order-picking container (1) and arranging the transport packaging (100) such that the opening (101) is pointing downwardly,
c) arranging the order-picking container (1) in the transport packaging (100) via the opening (101),
d) moving the order-picking container (1) arranged in the transport packaging (100) to a retransferring and separating station (30),
e) retransferring the at least one article (A) from the order-picking container (1) into the transport packaging (100) by performing a turning movement of the order-picking container (1) arranged the transport packaging (100) in relation to the vertical,
f) separating the order-picking container (1) from the transport packaging (100) containing the at least one article (A), and
g) closing the transport packaging (100),
wherein all steps a) through g) are performed in automated fashion by machine in a continuous process.

20. The method as claimed in claim 19, wherein the step a) comprises moving the order-picking container (1) to the transfer location (10) and tilting the order-picking container (1) such that an opening (1′) of the order-picking container (1) is facing in a direction of an article supply apparatus (15) providing the at least one article (A) so the at least one article (A) slides from the supply apparatus (15) into the order-picking container (1).

21. The method as claimed in claim 20, wherein moving the order-picking container (1) to the transfer location (10) is carried out such that a side of the order-picking container (1)
which has a lowest point (2a) or a lower edge (2a′) at a container margin that delimits the opening (1′), and/or
at which an acute-angled side of a wedge (8) which is arranged at the base of the order-picking container (1) is present, points toward the article supply apparatus (15).

22. The method as claimed in claim 19, further comprising:
in accordance with the order, repeating the step a) for at least one further article (A) at a further predetermined transfer location of the transfer station or at the same transfer location (20),
before the step b), moving the order-picking container (1) to a predetermined additional-material location (19) and transferring predetermined additional material into the order-picking container (1),
in the step b), providing the transport packaging (100) includes selecting a transport packaging (100) with a particular format in accordance with a quantity and/or a volume of the at least one article (A) of the order, from a magazine apparatus, setting up the transport packaging (100), and holding the transport packaging (100),
in the step c), moving the order-picking container (1) upward in order to insert the order-picking container (1) into the transport packaging (100) via the opening (101),
in the step d), moving the order-picking container (1) arranged in the transport packaging (100) includes passing a labelling station (29) and labelling the transport packaging (100),
in the step e), performing the turning movement includes guiding the order-picking container (1) arranged in the transport packaging (100) in a half-looping track (31) and supporting a base of the transport packaging (100) by a stabilizing track (32),
in the step f), separating the order-picking container (1) includes lifting the order-picking container (1) out of the transport packaging (100) by guiding the order-picking container (1) and the transport packaging (100) along tracks (33, 34) diverging in relation to the vertical,
in the step g), closing includes folding over or rolling up a portion of the transport packaging (100), proceeding from a side of the opening (101), as far as the at least one article (A) and fixing the portion that has been folded over or rolled up,
parallel to the step g), returning the order-picking container (1) by performing a further turning movement in relation to the vertical and moving the order-picking container (1) to the transfer station to pick up articles (A) in accordance with a further order.

23. An order-picking and packing installation for automatic order-picking and packaging of articles (A) for shipment, the order-picking and packing installation comprising:
order-picking containers (1);
a transfer station configured to transfer articles into the order-picking containers (1);
a packing station configured to pack the articles (A) into transport packagings (100);
a retransferring and separating station (30);
conveying devices (9, 14, 22) configured to convey the order-picking containers (1), wherein the conveying devices (9, 14, 22) connect the transfer station to the packing station and connect the packing station to the retransferring and separating station (30) arranged downstream of the packing station;
wherein the packing station comprises a packing location (20) and a transport packaging supply apparatus (21) arranged above the packing location (20) and configured to provide the transport packagings (100), wherein the transport packagings (100) comprise an opening (101) and the opening (101) is arranged to point downwardly at the packing location (20), wherein the opening (101) is dimensioned to receive the order-picking containers (1);
wherein at least one of the packing location (20) and of the transport packaging supply apparatus (21) is configured to perform a relative movement with respect to one another;
wherein the retransferring and separating station (30) comprises a first turning apparatus (31, 32) configured to perform a turning movement of the order-picking containers (1) in relation to the vertical, and further comprises, downstream of the first turning apparatus (31, 32), a separating apparatus (33, 34) configured to separate the order-picking containers (1) from the transport packagings (100).

24. The order-picking and packing installation as claimed in claim 23, further comprising a return device configured to return the order-picking containers (1) to the transfer station, wherein the return device comprises a second turning apparatus (31R) configured to perform a turning movement of the order-picking containers (1) in relation to the vertical.

25. The order-picking and packing installation as claimed in claim 23, further comprising a closure station (40) configured to close the transport packagings (100), wherein the closure station (40) is downstream of the retransferring and separating station (30), wherein the closure station (40) comprises an apparatus configured to fold over or roll up a portion of the transport packagings (100) proceeding from a side of the opening (101).

26. The order-picking and packing installation as claimed in claim 23, further comprising a supply apparatus (15) for the articles (A), wherein the supply apparatus (15) comprises a transfer apparatus (12), wherein the transfer station comprises transfer locations (10) and each transfer location (10) has assigned a tilting ramp (11) connecting, on its own or in interaction with the transfer apparatus (12), at a predetermined inclination angle a plane of the transfer location (10) to a plane, situated thereabove, of the supply apparatus (15) for the articles (A), wherein the tilting ramp (11) is designed to support the order-picking containers (1) at the predetermined inclination angle, wherein an opening (1′) of the order-picking container (1) points in a direction of the supply apparatus (15) in order to receive the articles (A).

27. The order-picking and packing installation as claimed in claim 23, further comprising an additional-material station (19) configured to supply predetermined additional material, wherein the additional-material station (19) is arranged along the conveying devices (9, 14, 22) between the transfer station (10) and the packing station (20).

28. The order-picking and packing installation as claimed in claim 23, further comprising a printer apparatus configured to print accompanying documentation, wherein the printer apparatus is configured such that a documentation output is situated above a plane defined by the opening (1′) of the order-picking containers (1) conveyed along the conveying devices (9, 14, 22).

29. The order-picking and packing installation as claimed in claim 23, further comprising a labelling station (29) configured to label the transport packagings (100), wherein the labelling station is arranged along the conveying devices (9, 14, 22) between the packing station (20) and the retransferring and separating station (30).

30. The order-picking and packing installation as claimed in claim 23, wherein the transport packaging supply apparatus (21) comprises:
a magazine apparatus with cassette carriers (21′) to accommodate transport packagings (100) of different formats;
a selection apparatus configured to select and isolate a transport packaging (100) of a particular format; and
a setting-up and holding apparatus configured to hold a selected and unfolded transport packaging (100) with the opening (101) pointing downwardly.

31. The order-picking and packing installation as claimed in claim 23, further comprising at least one lifting apparatus (13) connected to the packing location (20) and/or to the transport packaging supply apparatus (21), wherein the at least one lifting apparatus (13) is configured to provide a relative movement of the order-picking containers (1) between the packing location (20) and the transport packaging supply apparatus (21), wherein the at least one lifting apparatus (13) comprises at least one lifting cylinder (13), a lifting scissor mechanism, an elevator, or a lift apparatus comprising at least one circulating conveyor.

32. The order-picking and packing installation as claimed in claim 23, wherein the first turning apparatus comprises a half-looping track (31) provided with guide means configured to guide the order-picking containers (1) and further comprises a stabilizing track (32) running parallel to the half-looping track (31) and supporting a base of the transport packagings (100).

33. The order-picking and packing installation as claimed in claim 32, wherein the separating apparatus comprises an upper track and a lower track (33, 34) diverging relative to each other with respect to the vertical, wherein the upper track (33) is configured to guide the order-picking containers (1) and adjoins the half-looping track (31), and wherein the lower track (34) is configured to guide the transport packagings (100) and adjoins the stabilizing track (32).

34. The order-picking and packing installation as claimed in claim 33, wherein the upper track (33) is a rising ramp (33) and comprises guide means, wherein the guide means in the half-looping track (31) and the guide means of the upper track (33) are lateral guide rails (31′) configured to engage rolling apparatuses (4a, 4b) of the order-picking containers (1), wherein the rolling apparatuses are arranged laterally on the order-picking containers (1) near a base of the order-picking containers (1).

35. The order-picking and packing installation as claimed in claim 32, further comprising a lift apparatus (36) configured to lift the order-picking containers (1), wherein the lift apparatus adjoins the half-looping track (31), and further comprising a holding location (36′) configured to hold the transport packagings (100) below the lift apparatus (36) along a conveying-away track (34), wherein the conveying-away track (34) adjoins the stabilizing track (32).

36. The order-picking and packing installation as claimed in claim 35, wherein the lift apparatus (36) comprises at least one circulating conveyor (37, 38) comprising at least one engagement element (37c, 38c) configured to engage an order-picking container (1) that has been turned.

37. The order-picking and packing installation as claimed in claim 23, further comprising at least one control apparatus connected to all apparatuses and conveying devices of the order-picking and packing installation for the purpose of automatic consolidated order-picking and packaging of the articles (A) for shipment in a continuous process, wherein the apparatuses and conveying devices of the order-picking and packing installation are equipped with one or more sensor arrangements which, for a closed-loop control of the processes, are coupled to the at least one control apparatus.

38. The order-picking and packing installation as claimed in claim 37, wherein the one or more sensor arrangements include a sensor arrangement configured to detect an identifying feature of each one of the order-picking containers (1) and arranged at the transfer station, at the packing station, at an additional-material station (19), at a labelling station (29), at the closure station (40) and/or at all conveyance-relevant decision positions along the conveying devices (9, 14, 22).

39. The order-picking and packing installation as claimed in claim 37, wherein the one or more sensor arrangements include sensor apparatuses (16) provided at the transfer station for the purpose of detecting a completed article transfer and/or for the purpose of detecting articles (A) protruding out of the order-picking container (1) in the transfer position.

40. The order-picking and packing installation as claimed in claim 37, wherein the one or more sensor arrangements include a sensor arrangement arranged at a magazine apparatus of the transport packaging supply apparatus (21) for the purpose of monitoring a stock of transport packagings (100) and for the purpose of automatically assigning new transport packagings (100).

41. The order-picking and packing installation as claimed in claim 37, wherein the one or more sensor arrangements include a sensor arrangement at each cassette carrier (21′) of a magazine apparatus of the transport packaging supply apparatus (21) for the purpose of determining and controlling a fill level and a position of the cassette carrier (21′).

42. The order-picking and packing installation as claimed in claim 37, wherein the one or more sensor arrangements include a sensor arrangement for the closure station (40) for the purpose of detecting a height of the transport packagings (100) conveyed past the closure station (40) in order to assign the transport packagings (100), dependent on a detected height, to a closure apparatus of the closure station.

43. The order-picking and packing installation as claimed in claim 37, wherein the one or more sensor arrangements include a fill height sensor arranged at the closure station (40) for the purpose of detecting a fill height of the articles in the transport packagings (100) in order to determine a number of folds for closing the transport packagings (100) and to assign the transport packagings (100) to a corresponding closure apparatus for folding over or rolling up a portion of the transport packaging (100) proceeding from a side of the opening (101).

44. The order-picking and packing installation as claimed in claim 23, wherein the order-picking containers (1) each comprise an opening (1′) which is inclined relative to a base surface of the order-picking containers (1), and further comprise lateral rolling apparatuses (4a, 4b) arranged near the base surface.

45. The order-picking and packing installation as claimed in claim 44, wherein the order-picking containers (1) each comprise a main body (6) provided with the opening (1′) and a trough-shaped stabilizing apparatus (5) increasing a standing surface of the order-picking containers (1), wherein the base surface is provided at the trough-shaped stabilizing apparatus (5).

46. The order-picking and packing installation as claimed in claim 45, wherein the main body (6) is arranged at right angles relative to the base surface, wherein the opening (1′) that is inclined relative to the base surface is delimited by a container margin having a lowest point (2a) and a highest point (2b).

47. The order-picking and packing installation as claimed in claim 45, wherein the main body (6) is arranged so as to be inclined by a predetermined angle (α) relative to the base surface, wherein the opening (1′) that is inclined relative to the base surface is provided with a lower edge (2a′) and a higher edge (2b′).

48. The order-picking and packing installation as claimed in claim 47, further comprising a wedge (8) composed of an elastically shock-damping material and arranged at a base of the main body (6).

49. The order-picking and packing installation as claimed in claim 48, wherein an acute-angled side of the wedge (8) is arranged on a side of the main body (6) at which the lower edge (2a′) is arranged at the container margin that delimits the opening (1′).
